(19) United States
(12) Patent Application Publication
(10) Pub. No.: US 2020/0023569 A1
(43) Pub. Date: Jan. 23, 2020

(54) METHOD AND SYSTEM FOR 4D PRINTING OF COMPOSITES

(71) Applicant: VALORBEC SOCIETE EN COMMANDITE, Montreal (CA)

(72) Inventor: SUONG VAN HOA, BROSSARD (CA)

(21) Appl. No.: 16/041,009

(22) Filed: Jul. 20, 2018

(51) Int. Cl. B29C 61/02; B29C 64/393; B29C 70/38; B29C 71/02; B33Y 10/00; B33Y 30/00; B33Y 50/02; B29C 64/147

(52) U.S. Cl. CPC B29C 61/02; B29C 64/393; B29C 70/382; B29C 64/147; B33Y 10/00; B33Y 30/00; B33Y 50/02; B29C 71/02

(57) ABSTRACT

Systems and methods for 4D printing of composites are described herein. A composite layer arrangement is obtained for forming a composite laminate having a substantially flat profile. A plurality of composite layers are deposited according to the composite layer arrangement to form the composite laminate. The composite laminate is activated to produce a curved composite structure.

### TECHNICAL FIELD

The present disclosure relates generally to manufacturing of composite products and, more particularly, to methods and systems for four-dimensional (4D) printing of composites.

### BACKGROUND OF THE ART

Composite structures may be made by placing many layers of composite materials into a mold. The mold would typically have the geometries of the final composite structure. If the final composite structure has curves, then conventionally the mold has corresponding curves. However, if a final composite structure has complex geometries, then the mold would also typically have complex geometries and may be more expensive to produce. Furthermore, for a large final composite structure, a large mold would typically be required, which may make using a mold undesirable, not practical and/or not feasible.

3D printing (also known as additive manufacturing) is a process that enables the efficient manufacturing of parts with complex shapes. While 3D printing allows for manufacturing of parts with complex shapes, the process may be time consuming depending on the complexity of the final product and as such may not be suitable for mass production of products with curves or complex shapes.

As such, there is a need for systems and methods for manufacturing of composite products with curves or complex shapes.

### SUMMARY

In one aspect, there is provided a method for four-dimensional printing of a composite structure, the method comprising: obtaining a composite layer arrangement for forming a composite laminate having a substantially flat profile; depositing a plurality of composite layers according to the composite layer arrangement to form the composite laminate, each one of the plurality of composite layers comprising longitudinal fibers having a longitudinal direction; and activating the composite laminate to produce the composite structure comprising at least one curvature.

In some embodiments, activating the composite laminate comprises: heating the composite laminate to a first temperature; and cooling the composite laminate from the first temperature to a second temperature to produce the composite structure comprising at least one curvature.

In some embodiments, obtaining the composite layer arrangement comprises: generating a model of the composite laminate; determining a reconfiguration of the composite laminate that is expected to occur when the composite laminate corresponding to the model is activated to produce the three-dimensional composite structure; and generating the composite layer arrangement based on the reconfiguration.

In some embodiments, generating the model of the composite laminate comprises modeling a shrinkage of resin used in the plurality of composite layers and modeling coefficients of thermal contraction of the plurality of composite layers.

In some embodiments, modeling comprises generating a laminate matrix indicative of shrinkage of the resin and of the coefficients of thermal contraction.

In some embodiments, determining the reconfiguration comprises determining a radius of curvature of the composite laminate that is expected to occur when the composite laminate corresponding to the model is activated.

In some embodiments, determining the reconfiguration comprises determining the reconfiguration based on a shrinkage of the resin used in the plurality of composite layers and on a difference in coefficients of thermal contraction of each layer of the plurality of composite layers.

In some embodiments, determining the reconfiguration comprises determining the reconfiguration due to heating of the composite laminate to the first temperature and cooling of the composite structure to the second temperature.

In some embodiments, determining the reconfiguration comprises determining the reconfiguration based on a temperate difference between the first temperature and the second temperature.

In one aspect, there is provided a system for four-dimensional printing of a composite structure, the system comprising: an automated fiber placement machine comprising: a fiber placement head for depositing a plurality of composite layers onto a surface; a control unit comprising at least one processing unit and a non-transitory computer-readable memory having stored thereon program instructions executable by the at least one processing unit for: obtaining a composite layer arrangement for forming a composite laminate having a substantially flat profile; and causing the fiber placement head to deposit the plurality of composite layers according to the composite layer arrangement to form the composite laminate, each one of the plurality of composite layers comprising longitudinal fibers having a longitudinal direction; and an activation unit for activating the composite laminate to produce the composite structure comprising at least one curvature.

### DESCRIPTION OF THE DRAWINGS

Reference is now made to the accompanying figures in which:

FIG. 1 is a schematic cross-sectional view of an example system for 4D printing of composites;

FIG. 2A is a flowchart illustrating an example method for 4D printing of composites in accordance with an embodiment;

FIG. 2B is a flowchart illustrating an example of the step of curing a composite laminate to produce a curved composite structure of FIG. 2A;

FIG. 2C is a flowchart illustrating an example of the step of determining a composite layer arrangement of FIG. 2A;

FIGS. 3A, 3B and 3C are cross-sectional views of composite laminates comprising a plurality of layers, in accordance with an embodiment;

FIG. 4A is an example of produced composite laminates corresponding to the composite laminates illustrated in FIGS. 3A, 3B and 3C;

FIG. 4B is an example of produced curved composite structures produced by curing the composite laminates of FIG. 4A;

FIG. 5A illustrates curves showing shrinkage for different amounts of curing agent;

FIG. 5B illustrates curves showing modulus development for different amounts of curing agent;

FIG. 6 illustrates an example curing cycle;

FIG. 7 illustrates a curved composite structure after curing;

FIG. 8A illustrates a curved configuration generally corresponding to the curve of the composite structures of FIG. 4B;

FIG. 8B illustrates edges curves for the composite structures of FIG. 4B;

FIG. 9 is a schematic diagram of an example computing system for implementing the method of FIGS. 2A and 2B in accordance with an embodiment;

FIG. 10 is a graph illustrating a variation of radii of curvature with response to the value of n (calculated values) in accordance with a specific and non-limiting example;

FIG. 11 is a graph illustrating the effect of values of n on bending section modulus in accordance with a specific and non-limiting example;

FIG. 12 illustrates a comparison between three configurations in accordance with a specific and non-limiting example;

FIG. 13 illustrates parameters for analysis of a curved beam in accordance with a specific and non-limiting example;

FIG. 14 is a graph illustrating variations of the spring constant with n for [0₂, 90ₙ], 12 inch long beam in accordance with a specific and non-limiting example;

FIG. 15 illustrates a flat stack of layers that become a curved spring (24 inch long sample) in accordance with a specific and non-limiting example;

FIG. 16 illustrates a sample under 3 point bending test in accordance with a specific and non-limiting example;

FIG. 17 is a graph illustrating load-displacement curves for a long sample (24 inch long, lower curve) and short sample (12 inch long, upper curve) in accordance with a specific and non-limiting example;

FIG. 18 is a graph illustrating load-strain in a long sample (24 inch long) in accordance with a specific and non-limiting example; and

FIG. 19 illustrates locations of mid plane, neutral surface and interface in accordance with a specific and non-limiting example.

It will be noted that throughout the appended drawings, like features are identified by like reference numerals.

### DETAILED DESCRIPTION

Methods and systems for four-dimensional (4D) printing of composites are described herein. More specifically, the manufacturing techniques described herein use 4D printing for producing a three-dimensional (3D) composite structure with curved feature(s) from a substantially flat stack of composite layers. By 3D printing of a substantially flat stack of composite layers and curing the substantially flat stack this may allow for manufacturing of a three-dimensional composite structure with curved feature(s) without using a mold having a corresponding shape and without 3D printing of complex shapes. This may allow for a reduction in manufacturing cost and/or time.

4D printing uses the same techniques of 3D printing through computer-programmed deposition of material in successive layers to create a 3D object. In addition, 4D printing adds the dimension of transformation over time. 4D printing may be used to produce a self-folding structure that can change its configuration under certain stimulating conditions (also known as an “activation process”), such as the absorption of a liquid (e.g., water) or the application of heat or light (e.g. ultraviolet (UV) light). By extending 4D printing techniques to composite manufacturing techniques, the composite layers may be designed such that the composite structure changes its configuration upon an activation process (e.g., curing with heat and cooling), then the composite structure with a curved configuration can be made without the need for a mold with curved features. Thus, this may allow for moldless composite manufacturing, for example.

The composite manufacturing techniques described herein may use automated fiber placement, or Hand Lay Up (HLU). Automated fiber placement can be considered a form of 3D printing using long and continuous fiber composites. The materials used in automated fiber placement are typically composed of longitudinal fibers and resin consolidated into sheets, tapes, or thin strips, commonly known as “tows.” Individual tows are manipulated by the fiber placement machine to form a layer of material that is deposited onto a tool surface. Parts are built up layer-by-layer, with tows of composite material, with the angle at which each layer is laid onto the tool surface being determined by the fiber placement machine. The composite material made by HLU are usually thin sheets stacked on top of each other, each sheet with a different orientation.

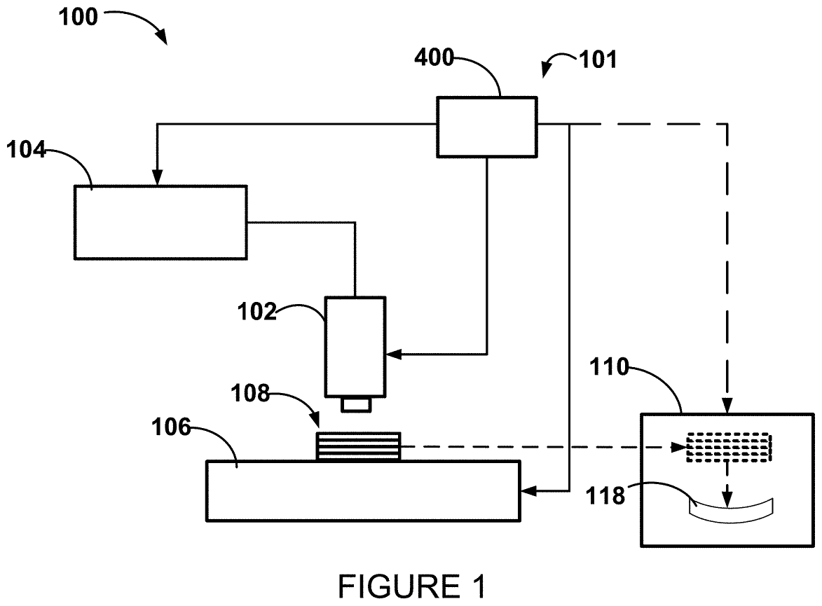

With reference to FIG. 1, an exemplary embodiment of a system 100 for 4D printing of composites is illustrated. The system 100 comprises at least one fiber placement head 102 for placing fiber tows supplied from at least one container 104 on to a tool surface 106. As illustrated, the tool surface 106 may be a substantially flat surface. At least one of the fiber placement head 102 and the tool surface 106 is movable in three directions (X-Y-Z). Accordingly, the fiber placement head 102 deposits a plurality of composite layers onto the tool surface 106 to produce a composite laminate 108 comprising a plurality of composite layers. In accordance with an embodiment, the system 100 is implemented using an automated fiber placement system 101 comprised of the fiber placement head 102, the container 104, and may also include the tool surface 106 and various other components. In accordance with a specific and non-limiting example of implementation the automated fiber placement system 101 may be a six degrees of freedom (or more) machine provided by Automated Dynamics. The machine may have thermoset placement head or thermoplastic placement head. Each head may handle one tow at a time or several tows simultaneously. 4D printing of composites may also be done by HLU where the layers are placed by hand, rather than by a machine.

The system 100 comprises an activation unit 110 for providing an activation process to produce a curved three-dimensional composite structure 118 from the composite laminate 108. The composite structure 118 comprises at least one curvature i.e., curved feature. The activation unit 110 may comprise: heating element(s), cooling element(s), light source(s), water source(s) and/or any other suitable components for implementing the activation process. The activation unit 110 may be a curing oven, or an autoclave. The activation unit 100 may be separate from the automated fiber placement system 101 or may be provided as part of the automated fiber placement system 101. The composite laminate 108 may be placed in the activation unit 110 manually by a person or automatically (e.g., by conveyor belts, robot) by the system 100. The activation unit 110 may be provided as part of the automated fiber placement system 101 and may not need to be moved to undergo the activation process after being deposited on the tool surface 106. In accordance with a specific and non-limiting example of implementation the activation unit 110 may be an autoclave. The autoclave may be any suitable autoclave provided by ASC Process Systems.

The system 100 comprises a control unit, such as a computing device 400 configured to control the operation of the automated fiber placement system 101 including controlling movement of the fiber placement head 102 and/or the tool surface 106. The computing device 400 is configured to receive composite layer arrangement data and to control the operation of the system 100 to generate the composite laminate 108. The computing device 400 may be configured to control the operation of the activation unit 110. Alternatively, the activation unit 110 may comprise a separate control unit of a type similar to that of the computing device 400. The system 100 may comprise any other suitable components (e.g., pumps, fans, valves, tubing, support structures, etc.).

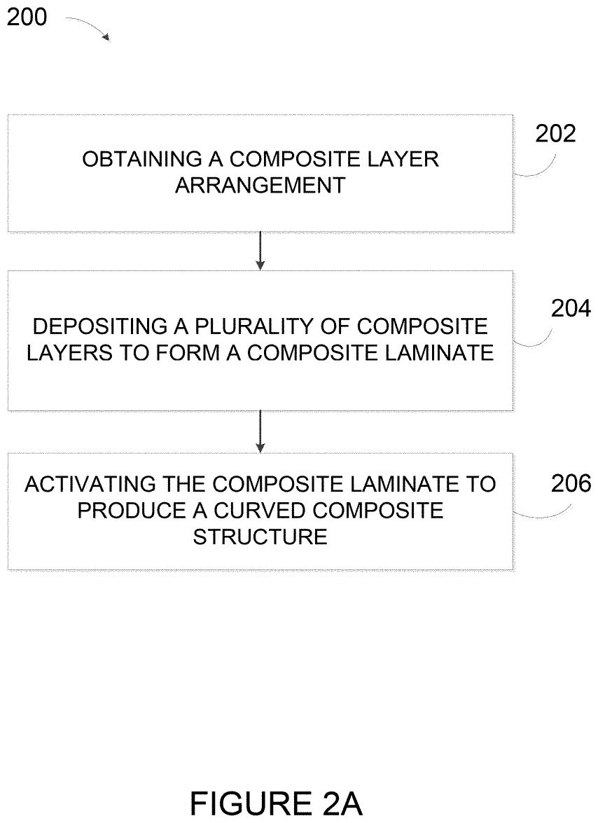

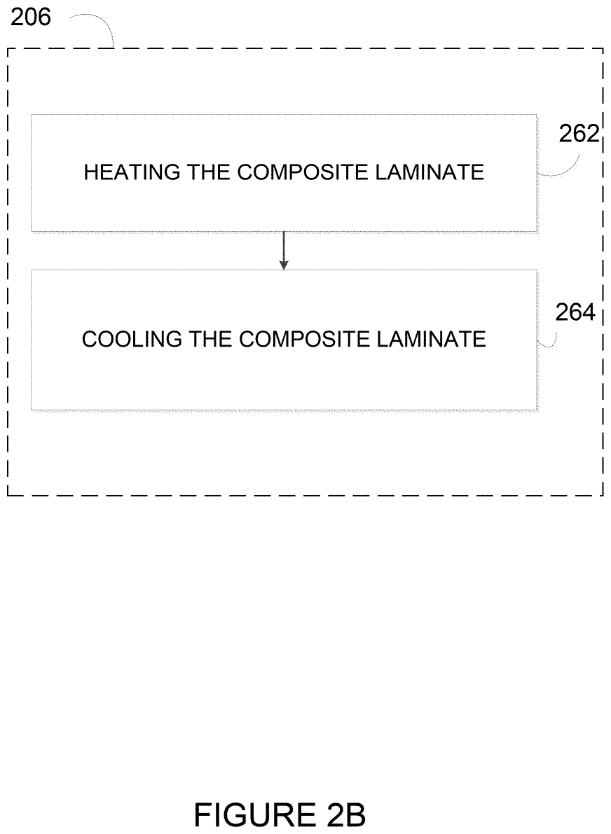

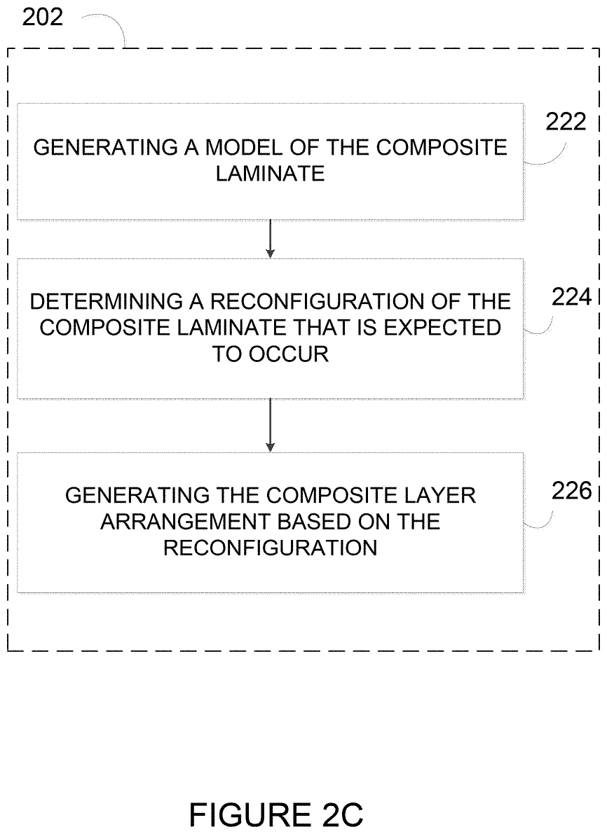

With reference to FIG. 2A, there is shown a flowchart illustrating an example method 200 for 4D printing of composites. The method 200 may be implemented at least in part by the system 100. While method 200 is described herein with reference to the system 100, this is for examplary purposes. The method 200 may be applied to any suitable system(s) for composite manufacturing.

At step 202, a composite layer arrangement is obtained. The composite layer arrangement is representative of a plurality of composite layers to be deposited to form the composite laminate 108. As described below, the composite layer arrangement may be in the form of computer instructions, numerical control for the automated printing layup of a composition laminate.

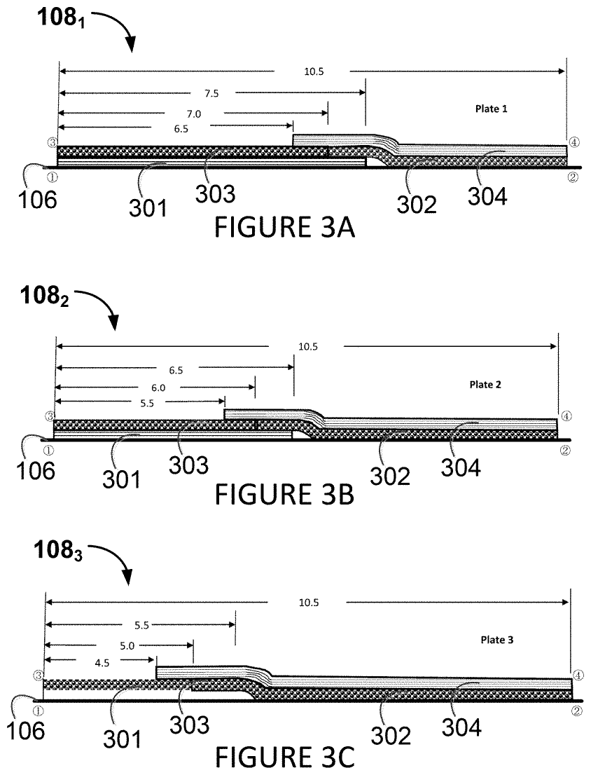

The composite laminate 108 has a substantially flat profile when viewed laterally, for example, as is shown in FIGS. 3A to 3C. Accordingly, the composite laminate 108 may be referred to as a substantially flat stack of composite layers. Each composite layer in the composite laminate 108 comprises longitudinal fibers and resin. The longitudinal fibers of each composite layer has a fiber orientation. Different layers may have different fiber orientations. The fiber orientation of a layer corresponds to a longitudinal direction of the longitudinal fibers of that layer. The fiber orientation may be defined as an angle at which the direction of the longitudinal fibers of that layer are deposited relative to a reference that is common to all of the layers.

The composite layer arrangement may be considered a model of the composite laminate 108 that is desired to be produced. The composite layer arrangement may specify the fiber orientation of each layer of the composite laminate 108. Accordingly, the composite layer arrangement may specify for each layer an angle at which a direction of the longitudinal fibers is to be deposited. The composite layer arrangement may specify for each layer the orientation of each layer relative to each other. For example, the composite layer arrangement may specify for each layer a position (e.g., an elevation) of each layer, a length for each layer, a width for each layer a thickness for each layer and/or any other suitable parameter indicative of orientation and/or position of the layers.

The composite layer arrangement may be obtained from a data file provided to the computing device 400 or may be generated at the computing device 400 based on user input. The composite layer arrangement may be provided as computer instructions for the control of the system 100. Alternatively, computer instructions for the control of the system 100 may be determined from the composite layer arrangement. For example, the computer instruction may comprise instructions for controlling movement of the fiber placement head 102 and/or the tool surface 106 and instructions for depositing of the composite layers to produce the composite laminate 108. The determination of the composite layer arrangement is described in further details elsewhere in this document.

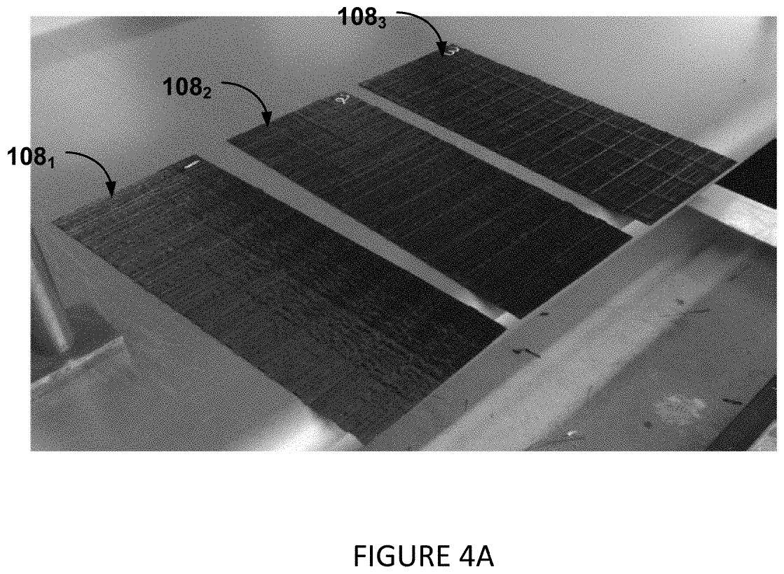

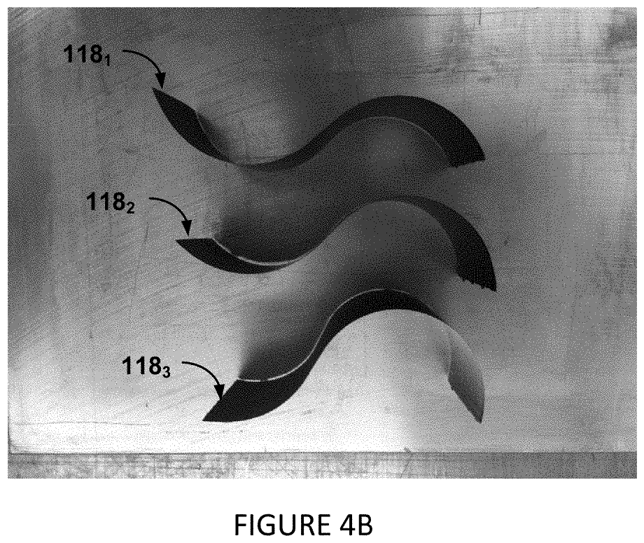

Referring back to FIG. 2A, at step 204, the plurality of composite layers are deposited according to the composite layer arrangement to form the composite laminate 108. Each layer deposited may be substantially flat, for example, as is shown in FIGS. 3A to 3C. As illustrated, the tool surface 106 may be substantially flat and a first substantially flat layer 301 may be deposited on the tool surface 106. A second substantially flat layer 302 is deposited at least in part on top of the first layer 301. As illustrated, part of the second layer 302 is deposited on the tool surface 106. While the second layer 302 is substantially flat, in this example the second layer 302 does include a portion that is non-flat due to the fact that the second layer 302 overlaps the first layer 301 onto the tool surface 106. FIG. 4A illustrates examples of formed composite laminates 108₁, 108₂, 108₃ corresponding to the illustrative examples of FIGS. 3A to 3C. The configuration in FIGS. 3A to 3C is exaggerated in thickness for illustration purposes. Since the thickness of each layer is very thin (e.g., 0.13 mm), the overlap creates a very slight deviation from flatness, and typically not as much as is shown in FIGS. 3A to 3C.

Referring back to FIG. 2A, at step 206, the composite laminate 108 is activated to produce the curved composite structure 118 having at least one curvature. For example, FIG. 4B illustrates curved composite structures 118₁, 118₂, 118₃ produced by activating the laminates 108₁, 108₂, 108₃ of FIG. 4A. The technique for activating the laminate 108 may vary depending on practical implementations.

With reference to FIG. 2B, there is illustrated an example embodiment of step 206 of FIG. 2A of activating the composite laminate 108. At step 262, the composite laminate 108 is heated to a first temperature. The first temperature may be referred to as a cure temperature. In some embodiments, the cure temperature is approximately 177° C. In accordance with an embodiment, the composite laminate 108 is almost flat at the cure temperature. At step 264, the curved composite structure 118 is produced by cooling the heated composite laminate 108 to a second temperature.. For example, the second temperature is room temperature.

Alternatively, any other suitable techniques for implementing an activation process for transforming the composite laminate 108 to produce the curved composite structure 118 may be performed at step 206.

With reference to FIG. 2C, there is illustrated an example embodiment of step 202 of FIG. 2A of obtaining the composite layer arrangement. In this example, at step 222, a model of the composite laminate 108 is generated. The model may specify the fiber orientation of each layer in the composite layer arrangement. The model may further specify the orientation and dimensions of each layer. The model may comprise other parameters such as the material properties, lay-up sequence of the layers, fiber orientation, thickness of the layers, the position of layers with different fiber orientations, the manufacturing process and/or any other suitable parameters. Generating the model may include modeling a shrinkage of resin used in the plurality of composite layers and modeling coefficients of thermal contraction of the plurality of composite layers.

Step 224 comprises determining a reconfiguration of the composite laminate 108 that is expected to occur when the composite laminate 108 corresponding to the model is cured to produce the composite structure 118. The reconfiguration of the composite layers 108 may depend on one or more parameters, such as the material properties, lay-up sequence of the layers, fiber orientation, thickness of the layers, the position of layers with different fiber orientations, the manufacturing process and/or any other suitable parameters.

The main mechanisms responsible for the reconfiguration of the composite laminate 108 are due to the anisotropy of the properties of the composite materials of each layer. The resin shrinkage due to curing gives rise to different amounts of deformation along the fiber direction and transverse to the fiber direction in a unidirectional layer. Also the different coefficients of thermal expansion (or contraction) of the fiber and the resin matrix give rise to different amounts of deformation due to a change in temperature of the layer. When layers having different fiber orientations (such as 0° and 90°) are bonded together to make an un-symmetric laminate, upon the action of either resin shrinkage or change in temperature (or both), the deformations of the different layers along different directions causes the laminate 108 to reconfigure, by the constraints of the laid-up layers on one another. By understanding, and controlling, the effect of the different lay-up sequences of the layers, one may produce a curved laminate without the need to use curved molds.

Accordingly, one parameter that affects the reconfiguration of the composite laminate 108 is the shrinkage of the matrix resin used in each layer. Another factor is the difference in coefficients of thermal contraction of the layers with different fiber orientations used to activate the change in shape of the composite layers upon curing and cooling. The expected reconfiguration of the composite laminate 108 may be determined taking into account one or more of the aforementioned parameters.

For example, determining the expected reconfiguration may comprise determining the reconfiguration based on a shrinkage of a matrix resin used in each layer and based on a difference in coefficients of thermal contraction of each layer. Determining the reconfiguration may comprise determining the reconfiguration due to heating of the composite laminate 108 to the first temperature and cooling of the composite structure 118 to the second temperature. Determining the reconfiguration may comprise determining the reconfiguration based on a temperate difference between the first temperature and the second temperature. Determining the reconfiguration may comprise determining a radius of curvature of the composite laminate 108 that is expected to occur when the composite laminate 108 corresponding to the model is cured to produce the composite structure 118. The determination of reconfiguration of the composite laminate 108 is described in further detail elsewhere in this document.

At step 226, the composite layer arrangement is generated based on the reconfiguration determined at step 224. The expected reconfiguration of the composite laminate 108 may be compared to a desired design requirement of the curved composite structure 118. If the expected reconfiguration meets the design requirement, then a composite layer arrangement corresponding to the model of the composite laminate 108 may be generated. For example, the expected reconfiguration may comprise a radius of curvature. If the radius of curvature meets the desired curvature of the composite structure 118, then a composite layer arrangement may be generated. The process in FIG. 2C may be repeated until an expected reconfiguration meets the design requirements. Computer modeling and/or numerical simulations may be performed to arrive at a composite layer arrangement.

The reconfiguration of the composite laminate 108 is now described in further detail. For thermoset matrix composites, the reconfiguration of the laminate 108 upon curing and cooling can be thought to be due to two mechanisms (with the assumption that the stiffness of the material is sufficiently high): One is the resin shrinkage due to chemical reactions between the molecules in the resin, and the other is due to mismatch in coefficients of thermal contraction along different directions in different layers in the laminate 108 upon cooling from the curing temperature down to room temperature. Each of these two mechanisms is described below and is further described in Suong Van Hoa, “Factors affecting the properties of composites made by 4D printing (moldless composites manufacturing)”, Journal of Advance Manufacturing: Polymer & Composite Science, 3:3, 101-109, DOI: 10.1080/20550340.2017.135519, Jul. 31, 2017, the contents of which are hereby incorporated by reference.

For curing of thermoset resin, the liquid resin transforms into a solid via chemical reaction between the molecules. This transformation can take place at different temperatures depending on the type of resin. The transformation can take place at room temperature for resins such as polyesters. For most aircraft types of composite where the resin is epoxy, the transformation usually takes place at higher temperature (about 180° C.). The temperature at which the majority of the transformation takes place is called the curing temperature. There is significant shrinkage of thermoset resin due to this transformation.

The effect of cure shrinkage and thermal contraction coefficients for the composite laminate 108 may be modeled. The process of resin cure and modulus development may be considered to consist of three phases. Phase 1 is when the resin is a liquid and the modulus of the material is almost zero. When the resin gels, the degree of cure is denoted α_{gel}^{mod}. During phase 2, the resin transforms from the gel state to the solid state, (from α_{gel}^{mod} to α_{diff}^{mod}) and the modulus increases to its saturated value. Most of the shrinkage occurs within this phase. Phase 3 is the saturation state when there is no further shrinkage or modulus development (due to shrinkage). Note that the modulus is very low for a good part of the shrinkage development. As such even though shrinkage occurs in the early stage, this shrinkage may not contribute to the reconfiguration of the final composite structure. The variation of temperature in the composite structure and the development of cure of the resin may be determined using energy balance and kinetic equations. Micromechanics equations may then be used to determine the lamina properties. Laminate equations may then be used to determine the residual stresses and curvatures.

Certain assumptions on the values of different properties may be made in order to proceed with the aforementioned analysis. For example, the range of the degree of cure for the development of the modulus (from α_{gel}^{mod} to α_{diff}^{mod}) is different from the total amount of shrinkage from the liquid state to the solid state and this may be assumed. Also, the transverse modulus of carbon fiber composite may be assumed. The development of the resin modulus may be assumed to take the form of the rule of mixture based on the development of cure. These and other assumptions may give rise to some degree of approximations to the result obtained.

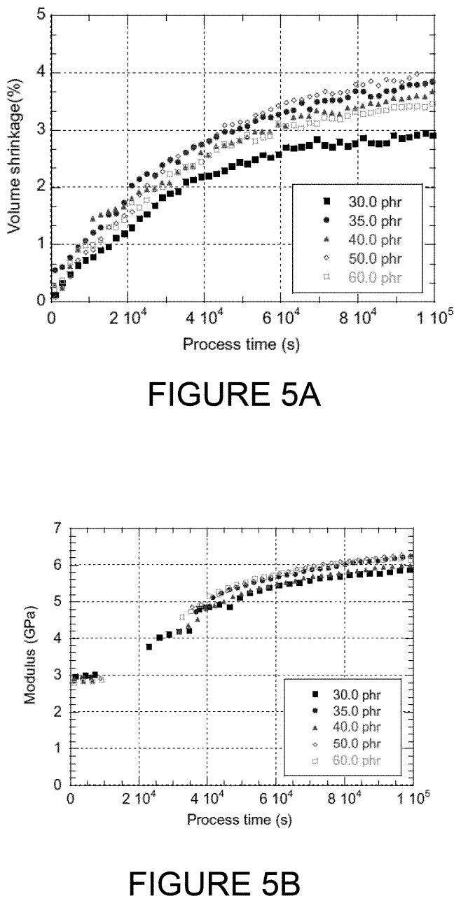

An ultrasonic method may be used to determine the developments of shrinkage and modulus of an epoxy resin. With reference to FIGS. 5A and 5B, curves illustrate examples of developments of shrinkage and modulus of an epoxy resin. In these figures, the amount of volume shrinkage and the values of the moduli depend on the amount of curing agents. In FIG. 5B, the modulus at the beginning of the curing process is about 3 GPa. As the process time increases up to about 40,000 s, there are discontinuities in the modulus curves. This is due to the loss of ultrasonic signals when they are trying to traverse the rubbery state of the resin. At 40,000 s, the modulus is about 5 GPa. After that time, the modulus shows continuous increase up to a final value of about 6 GPa. Assuming that the significant reconfiguration takes place only after the modulus has reached its final saturation state, the corresponding period of time is from about 80,000 s to 100,000 s. The volume shrinkage varies from about 3.4 to 3.6% (taking the case of 40 phr). The resin shrinkage range is taken to be the difference between 3.6 and 3.4% (0.2%). The relation between volumetric shrinkage and linear shrinkage for an isotropic material can be as follows:

Relation between change ΔV and liner change Δx:

$$\frac{Δ V}{V} = \frac{{( x - Δ x )}^{3} - {x}^{3}}{{x}^{3}} \approx 3 \frac{Δ x}{x} \qquad ( 1 )$$

A volumetric shrinkage of 0.2% would correspond to a linear shrinkage of 0.066%.

The contribution to the reconfiguration for cooling from the curing temperate to room temperature may be determined. Based on a normal manufacturing procedure for long fiber composites, after the sample is cured, it is cooled from the cure temperature to room temperature. The difference in the contractions of layers of different fiber orientations contributes to the reconfiguration of the composite laminate 108. Laminate theory may be used to determine the radius of curvature of at least one curve of three-dimensional composite structure 118. Strains and curvatures of the composite structure 118 due to shrinkage and thermal effects can be obtained using the procedure outlined below:

The laminar properties of carbon/epoxy composites are given in Table 1. Values for the shrinkage coefficients are obtained using the above discussion.

TABLE 1
Properties of the constituents

| | |
|---|---|
| E₁ (GPa) | 155.0 |
| E₂ (GPa) | 12.10 |
| G₁₂ (GPa) | 4.40 |
| v₁₂ | 0.248 |
| α₁ (10^{-6%/°} ^{C.}) | −0.018 |
| α₂ (10^{-6%/°} ^{C.}) | 24.3 |
| β₁ (%) | 0 |
| β₂ (%) | 0.066 |

A laminate matrix for the model of the composite laminate 108 may be determined. The laminate matrix is a mathematical expression indicative of a reconfiguration of a composite laminate due to shrinkage of the resin of the layers and thermal contraction of the layers. The laminate matrix may be determined as follows:

$$\begin{matrix}{A}_{ij} = \int \overline{{Q}_{ij}} dz {B}_{ij} = \int \overline{{Q}_{ij}} zdz {D}_{ij} = \int \overline{{Q}_{ij}} {z}^{2} dz \\ where i , j = 1 , 2 , 6 ; and & ( 2 ) \\ \overline{{Q}_{11}} = {Q}_{11} {m}^{4} + 2 ( {Q}_{12} + 2 {Q}_{66} ) {n}^{2} {m}^{2} + {Q}_{22} {n}^{4} \\ \overline{{Q}_{12}} = ( {Q}_{11} + {Q}_{22} - 4 {Q}_{66} ) {n}^{2} {m}^{2} + {Q}_{12} ( {n}^{4} + {m}^{4} ) \\ \overline{{Q}_{16}} = ( {Q}_{11} - {Q}_{12} - 2 {Q}_{66} ) {nm}^{3} + ( {Q}_{12} - {Q}_{22} + 2 {Q}_{66} ) {n}^{3} m \\ \overline{{Q}_{22}} = {Q}_{11} {n}^{4} + 2 ( {Q}_{12} + 2 {Q}_{66} ) {n}^{2} {m}^{2} + {Q}_{22} {n}^{4} \\ \overline{{Q}_{26}} = ( {Q}_{11} - {Q}_{12} - 2 {Q}_{66} ) {n}^{3} m + ( {Q}_{12} - {Q}_{22} + 2 {Q}_{66} ) {nm}^{3} \\ \overline{{Q}_{66}} = ( {Q}_{11} + {Q}_{22} - 2 {Q}_{12} - 2 {Q}_{66} ) {n}^{2} {m}^{2} + {Q}_{66} ( {n}^{4} + {m}^{4} ) \\ and & ( 3 ) \\ {Q}_{11} = \frac{{E}_{1}}{1 - {v}_{12} {v}_{21}} \\ {Q}_{12} = \frac{{v}_{12} {E}_{2}}{1 - {v}_{12} {v}_{21}} = \frac{{v}_{21} {E}_{2}}{1 - {v}_{12} {v}_{21}} \\ {Q}_{22} = \frac{{E}_{2}}{1 - {v}_{12} {v}_{21}} \\ {Q}_{66} = {G}_{12} & ( 4 )\end{matrix}$$

and E₁, E₂, G₁₂ , v₁₂ and v₂₁ are moduli and Poisson ratios of a layer, respectively, and were given in Table 1.

Also, m=cos θ and n=sin θ where θ is the angle between the fiber direction in a layer relative to the X-axis of the composite laminate 108.

For the case of a laminate subject to a temperature change ΔT, the relations for the strains and curvatures are given as:

$$[ \begin{matrix}{ɛ}_{x}^{0} \\ {ɛ}_{y}^{0} \\ {γ}_{xy}^{0} \\ {κ}_{x}^{0} \\ {κ}_{y}^{0} \\ {κ}_{xy}^{0}\end{matrix} ] = [ \begin{matrix}{a}_{11} & {a}_{12} & {a}_{16} & {b}_{11} & {b}_{12} & {b}_{16} \\ {a}_{12} & {a}_{22} & {a}_{26} & {b}_{21} & {b}_{22} & {b}_{26} \\ {a}_{16} & {a}_{26} & {a}_{66} & {b}_{61} & {b}_{62} & {b}_{66} \\ {b}_{11} & {b}_{21} & {b}_{61} & {d}_{11} & {d}_{12} & {d}_{16} \\ {b}_{12} & {b}_{22} & {b}_{62} & {d}_{12} & {d}_{22} & {d}_{26} \\ {b}_{16} & {b}_{26} & {b}_{66} & {d}_{16} & {d}_{26} & {d}_{66}\end{matrix} ] [ \begin{matrix}{N}_{x}^{T} \\ {N}_{y}^{T} \\ {N}_{xy}^{T} \\ {M}_{x}^{T} \\ {M}_{y}^{T} \\ {M}_{xy}^{T}\end{matrix} ] \qquad ( 5 )$$

Similarly for a laminate subject to shrinkage, one has the relation:

$$[ \begin{matrix}{ɛ}_{x}^{0} \\ {ɛ}_{y}^{0} \\ {γ}_{xy}^{0} \\ {κ}_{x}^{0} \\ {κ}_{y}^{0} \\ {κ}_{xy}^{0}\end{matrix} ] = [ \begin{matrix}{a}_{11} & {a}_{12} & {a}_{16} & {b}_{11} & {b}_{12} & {b}_{16} \\ {a}_{12} & {a}_{22} & {a}_{26} & {b}_{21} & {b}_{22} & {b}_{26} \\ {a}_{16} & {a}_{26} & {a}_{66} & {b}_{61} & {b}_{62} & {b}_{66} \\ {b}_{11} & {b}_{21} & {b}_{61} & {d}_{11} & {d}_{12} & {d}_{16} \\ {b}_{12} & {b}_{22} & {b}_{62} & {d}_{12} & {d}_{22} & {d}_{26} \\ {b}_{16} & {b}_{26} & {b}_{66} & {d}_{16} & {d}_{26} & {d}_{66}\end{matrix} ] [ \begin{matrix}{N}_{x}^{S} \\ {N}_{y}^{S} \\ {N}_{xy}^{S} \\ {M}_{x}^{S} \\ {M}_{y}^{S} \\ {M}_{xy}^{S}\end{matrix} ] \qquad ( 5 a )$$

where the column on the left hand side represents the in-plane strains and curvatures at the mid-plane of the laminate, the square matrix represents components of a compliance, and the column on the right hand side represents the thermal stress resultants (or shrinkage stress resultants), and thermal moment resultants (or shrinkage moment resultants), respectively.

For a laminate made of thermoset matrix composites, the shrinkage effect takes place during the curing of the resin which occurs at relatively high temperature. Subsequently, upon cooling from the cure temperature to room temperature, the difference in thermal contraction of layers at different fiber orientations also gives rise to residual stresses. These stresses in turn contribute to the reconfiguration.

The inverse of the relations (5) and (5a) are:

$$\begin{matrix}[ \begin{matrix}{N}_{x}^{T} \\ {N}_{y}^{T} \\ {N}_{xy}^{T} \\ {M}_{x}^{T} \\ {M}_{y}^{T} \\ {M}_{xy}^{T}\end{matrix} ] = [ \begin{matrix}{A}_{11} & {A}_{12} & {A}_{16} & {B}_{11} & {B}_{12} & {B}_{16} \\ {A}_{12} & {A}_{22} & {A}_{26} & {B}_{21} & {B}_{22} & {B}_{26} \\ {A}_{16} & {A}_{26} & {A}_{66} & {B}_{61} & {B}_{62} & {B}_{66} \\ {B}_{11} & {B}_{21} & {B}_{61} & {D}_{11} & {D}_{12} & {D}_{16} \\ {B}_{12} & {B}_{22} & {B}_{62} & {D}_{12} & {D}_{22} & {D}_{26} \\ {B}_{16} & {B}_{26} & {B}_{66} & {D}_{16} & {D}_{26} & {D}_{66}\end{matrix} ] [ \begin{matrix}{ɛ}_{x}^{0} \\ {ɛ}_{y}^{0} \\ {γ}_{xy}^{0} \\ {κ}_{x}^{0} \\ {κ}_{y}^{0} \\ {κ}_{xy}^{0}\end{matrix} ] \\ and & ( 6 ) \\ [ \begin{matrix}{N}_{x}^{s} \\ {N}_{y}^{s} \\ {N}_{xy}^{s} \\ {M}_{x}^{s} \\ {M}_{y}^{s} \\ {M}_{xy}^{s}\end{matrix} ] = [ \begin{matrix}{A}_{11} & {A}_{12} & {A}_{16} & {B}_{11} & {B}_{12} & {B}_{16} \\ {A}_{12} & {A}_{22} & {A}_{26} & {B}_{21} & {B}_{22} & {B}_{26} \\ {A}_{16} & {A}_{26} & {A}_{66} & {B}_{61} & {B}_{62} & {B}_{66} \\ {B}_{11} & {B}_{21} & {B}_{61} & {D}_{11} & {D}_{12} & {D}_{16} \\ {B}_{12} & {B}_{22} & {B}_{62} & {D}_{12} & {D}_{22} & {D}_{26} \\ {B}_{16} & {B}_{26} & {B}_{66} & {D}_{16} & {D}_{26} & {D}_{66}\end{matrix} ] [ \begin{matrix}{ɛ}_{x}^{0} \\ {ɛ}_{y}^{0} \\ {γ}_{xy}^{0} \\ {κ}_{x}^{0} \\ {κ}_{y}^{0} \\ {κ}_{xy}^{0}\end{matrix} ] & ( 6 a )\end{matrix}$$

where Aᵢⱼ, Bᵢⱼ, Dᵢⱼ are given by Equation (2).

Equation (5) can be abbreviated as:

(ε)=[C](R) (7)

and Equation (6) can be abbreviated as:

(R)=[S](ε) (8)

where [C] is the compliance matrix and [S] is the stiffness matrix, and we have:

[C]=[S]⁻¹ (9)

Also, the thermal stress resultants and thermal moment resultants are given as

$$\begin{matrix}{N}_{x}^{T} = {\int }_{- \frac{H}{2}}^{\frac{H}{2}} ( \overline{{Q}_{11}} {α}_{x}^{T} + \overline{{Q}_{12}} {α}_{y}^{T} + \overline{{Q}_{16}} {α}_{xy}^{t} ) Δ Tdz & ( 10 a ) \\ {N}_{y}^{T} = {\int }_{- \frac{H}{2}}^{\frac{H}{2}} ( \overline{{Q}_{12}} {α}_{x}^{T} + \overline{{Q}_{22}} {α}_{y}^{T} + \overline{{Q}_{26}} {α}_{xy}^{t} ) Δ Tdz & ( 10 b ) \\ {N}_{xy}^{T} = {\int }_{- \frac{H}{2}}^{\frac{H}{2}} ( \overline{{Q}_{16}} {α}_{x}^{T} + \overline{{Q}_{26}} {α}_{y}^{T} + \overline{{Q}_{66}} {α}_{xy}^{t} ) Δ Tdz & ( 10 c ) \\ {M}_{x}^{T} = {\int }_{- \frac{H}{2}}^{\frac{H}{2}} ( \overline{{Q}_{11}} {α}_{x}^{T} + \overline{{Q}_{12}} {α}_{y}^{T} + \overline{{Q}_{16}} {α}_{xy}^{t} ) Δ Tzdz & ( 10 d ) \\ {M}_{y}^{T} = {\int }_{- \frac{H}{2}}^{\frac{H}{2}} ( \overline{{Q}_{12}} {α}_{x}^{T} + \overline{{Q}_{22}} {α}_{y}^{T} + \overline{{Q}_{26}} {α}_{xy}^{t} ) Δ Tzdz & ( 10 e ) \\ {M}_{xy}^{T} = {\int }_{- \frac{H}{2}}^{\frac{H}{2}} ( \overline{{Q}_{16}} {α}_{x}^{T} + \overline{{Q}_{26}} {α}_{y}^{T} + \overline{{Q}_{66}} {α}_{xy}^{t} ) Δ Tzdz & ( 10 f )\end{matrix}$$

where the α's are the off-axis coefficient of thermal expansion and are given as:

αₓ=α₁m²+α₂n²α_{y}=α₁n²+α₂m²α_{xy}=2(α₁−α₂)mn (11)

and α₁ and α₂are on-axis coefficients of thermal expansion of a particular layer, and were given in Table 1. On-axis refers to along the fiber direction (parallel) and transverse (perpendicular) to the fiber direction. Off-axis refers to any other direction apart from the parallel and perpendicular directions.

Similarly for shrinkage, the equations are:

$$\begin{matrix}{N}_{x}^{S} = {\int }_{- \frac{H}{2}}^{\frac{H}{2}} ( \overline{{Q}_{11}} {ɛ}_{x}^{T} + \overline{{Q}_{12}} {ɛ}_{y}^{T} + \overline{{Q}_{16}} {ɛ}_{xy}^{t} ) Δ Tdz & ( 12 a ) \\ {N}_{y}^{S} = {\int }_{- \frac{H}{2}}^{\frac{H}{2}} ( \overline{{Q}_{12}} {ɛ}_{x}^{T} + \overline{{Q}_{22}} {ɛ}_{y}^{T} + \overline{{Q}_{26}} {ɛ}_{xy}^{t} ) Δ Tdz & ( 12 b ) \\ {N}_{xy}^{S} = {\int }_{- \frac{H}{2}}^{\frac{H}{2}} ( \overline{{Q}_{16}} {ɛ}_{x}^{T} + \overline{{Q}_{26}} {ɛ}_{y}^{T} + \overline{{Q}_{66}} {ɛ}_{xy}^{t} ) Δ Tdz & ( 12 c ) \\ {M}_{x}^{S} = {\int }_{- \frac{H}{2}}^{\frac{H}{2}} ( \overline{{Q}_{11}} {ɛ}_{x}^{T} + \overline{{Q}_{12}} {ɛ}_{y}^{T} + \overline{{Q}_{16}} {ɛ}_{xy}^{t} ) Δ Tzdz & ( 12 d ) \\ {M}_{y}^{S} = {\int }_{- \frac{H}{2}}^{\frac{H}{2}} ( \overline{{Q}_{12}} {ɛ}_{x}^{T} + \overline{{Q}_{22}} {ɛ}_{y}^{T} + \overline{{Q}_{26}} {ɛ}_{xy}^{t} ) Δ Tzdz & ( 12 e ) \\ {M}_{xy}^{S} = {\int }_{- \frac{H}{2}}^{\frac{H}{2}} ( \overline{{Q}_{16}} {ɛ}_{x}^{T} + \overline{{Q}_{26}} {ɛ}_{y}^{T} + \overline{{Q}_{66}} {ɛ}_{xy}^{t} ) Δ Tzdz & ( 12 f )\end{matrix}$$

where the off-axis shrinkage strains are obtained by:

εₓ^{s}β₁m²+β₂n²ε_{y}^{s}=β₁n²+βm²ε_{xy}^{s}=2(β₁−β₂)mn (13)

where β₁and β₂are the coefficient of shrinkage of a unidirectional layer, along the fiber direction, and transverse to the fiber direction, respectively, and were given in Table 1. By obtaining the strains and curvatures as shown in Equation (5), the deformation of the laminate 108 due to shrinkage during curing, or cooling down from either the curing temperature (or processing temperature), may be obtained.

A specific and non-limiting example of the above is now presented to determine the curvature of a composite laminate made using [0/90] stacking sequence. The expression [0/90] refers to a laminate having two layers. One layer has fibers oriented at 0 degree (parallel to length of the laminate). The other layer has fibers at 90 degree (perpendicular to the length of the laminate). This example is a simple example to illustrate determine the curvature of a composite laminate and it should be appreciated that the determination of the curvature of the composite laminate varies depending on practical implementations. In this example, the stacking sequence used results in an un-symmetric laminate and it may curl upon curing and cooling from the curing temperature.

As such, ε₁^{s}=0 and ε₂^{s}=−0.00066. For 0° layer: εₓ^{s}=0, ε_{y}^{s}=−0.00066 and ε_{xy}^{s}=0. For 90° layer: εₓ^{s}=−0.00066 , ε_{y}^{s}=0 and ε_{xy}^{s}=0.

The contribution from difference in coefficients of thermal contraction upon cooling may be determined. In this example, the curing temperature is 177° C. The thickness of each layer is 0.125 mm. The curvature can be calculated using the formulation as follows:

From Equation (4):

Q₁₁=155.7 GPa, Q₁₂=3.02 GPa, Q₂₂=12.16 GPa, Q₆₆=4.40 GPa (14)

From Equation (3), for the 0° layer:

Q̅₁̅₁̅=155.7 GPa, Q̅₁̅₂̅=3.02 GPa, Q̅₂̅₂̅=12.16 GPa , Q̅₆̅₆̅=4.40 GPa Q̅₁̅₆̅=0 GPa, Q̅₂̅₆̅=0 GPa (15)

And for the 90° layer:

Q̅₁̅₁̅=12.6 GPa, Q̅₁̅₂̅=3.02 GPa, Q̅₂̅₂̅=155.7 GPa , Q̅₆̅₆̅=4.40 GPa Q̅₁̅₆̅=0 GPa, Q̅₂̅₆̅=0 GPa (16)

From Equation (11), for 0° layer:

αₓ=−0.018×10⁻⁶/Cα_{y}=24.3×10⁻⁶/Cα_{xy}=0 (17)

And for 90° layer:

αₓ=24.3×10⁻⁶/Cα_{y}=−0.018×10⁻⁶/Cα_{xy}=0 (17)

From Equation (2):

$$\begin{matrix}{A}_{11} = h ( 155.7 + 12.16 ) = 167.86 h ( Gpa - m ) \\ {A}_{12} = h ( 3.02 + 3.02 ) = 6.04 h ( Gpa - m ) \\ {A}_{22} = h ( 12.16 + 155.7 ) = 167.86 h ( Gpa - m ) \\ {A}_{66} = h ( 4.40 + 4.40 ) = 8.80 h ( Gpa - m ) \\ {A}_{16} = 0 \\ {A}_{26} = 0 \\ and & ( 19 ) \\ {B}_{11} = - \frac{{h}^{2}}{2} ( 155.7 ) + \frac{{h}^{2}}{2} ( 12.16 ) = - 71.77 {h}^{2} \\ {B}_{12} = - \frac{{h}^{2}}{2} ( 12.6 ) + \frac{{h}^{2}}{2} ( 155.7 ) = 71.77 {h}^{2} \\ {B}_{22} = 0 \\ {B}_{66} = 0 \\ {B}_{16} = 0 \\ {B}_{26} = 0 \\ and & ( 20 ) \\ {D}_{11} = - \frac{{h}^{3}}{3} ( 155.7 + 12.16 ) = 55.95 {h}^{3} \\ {D}_{12} = 55.95 {h}^{3} \\ {D}_{22} = 2.01 {h}^{3} \\ {D}_{66} = 2.93 {h}^{3} \\ {D}_{16} = 0 \\ {D}_{26} = 0 & ( 21 )\end{matrix}$$

The stiffness matrix can be written as:

$$[ S ] = [ \begin{matrix}167.86 h & 6.04 h & 0 & - 71.77 {h}^{2} & 0 & 0 \\ 6.04 h & 167.86 h & 0 & 0 & 71.77 {h}^{2} & 0 \\ 0 & 0 & 8.8 h & 0 & 0 & 0 \\ - 71.77 {h}^{2} & 0 & 0 & 55.95 {h}^{3} & 2.01 {h}^{3} & 0 \\ 0 & 71.77 {h}^{2} & 0 & 2.01 {h}^{3} & 55.95 {h}^{3} & 0 \\ 0 & 0 & 0 & 0 & 0 & 2.93 {h}^{3}\end{matrix} ] \qquad ( 22 )$$

Due to the present of the zeros, the stiffness relation can be broke down into three separate equations as:

$$\begin{matrix}[ \begin{matrix}{N}_{x}^{T} + {N}_{x}^{S} \\ {N}_{y}^{T} + {N}_{y}^{S} \\ {M}_{x}^{T} + {M}_{x}^{S} \\ {M}_{y}^{T} + {M}_{y}^{S}\end{matrix} ] = [ \begin{matrix}{A}_{11} & {A}_{12} & {B}_{11} & 0 \\ {A}_{12} & {A}_{22} & 0 & {B}_{22} \\ {B}_{11} & 0 & {D}_{11} & {D}_{12} \\ 0 & {B}_{22} & {D}_{12} & {D}_{22}\end{matrix} ] [ \begin{matrix}{ɛ}_{x}^{0} \\ {ɛ}_{y}^{0} \\ {κ}_{x}^{0} \\ {κ}_{y}^{0}\end{matrix} ] & ( 23 ) \\ {N}_{xy}^{T} + {N}_{xy}^{S} = {A}_{66} {γ}_{xy}^{0} & ( 24 ) \\ {M}_{xy}^{T} + {M}_{xy}^{S} = {D}_{66} {κ}_{xy} & ( 25 )\end{matrix}$$

Solving Equation (23) yields:

$$\begin{matrix}{κ}_{x} = \frac{1}{{B}_{11}} [ {N}_{x}^{T} + {N}_{x}^{S} - {A}_{11} {ɛ}_{x}^{0} - {A}_{12} {ɛ}_{y}^{0} ] & ( 26 ) \\ {κ}_{y} = \frac{1}{{B}_{22}} [ {N}_{y}^{T} + {N}_{y}^{S} - {A}_{12} {ɛ}_{x}^{0} - {A}_{22} {ɛ}_{y}^{0} ] & ( 27 ) \\ {ɛ}_{x}^{0} = \frac{{Y}_{2} ( {M}_{x}^{T} + {M}_{x}^{S} - {X}_{3} ) - {X}_{2} ( {M}_{y}^{T} + {M}_{y}^{S} - {Y}_{3} )}{{Y}_{2} {X}_{1} - {Y}_{1} {X}_{2}} & ( 28 ) \\ {ɛ}_{y}^{0} = \frac{{Y}_{1} ( {M}_{x}^{T} + {M}_{x}^{S} - {X}_{3} ) - {X}_{1} ( {M}_{y}^{T} + {M}_{y}^{S} - {Y}_{3} )}{{Y}_{1} {X}_{2} - {Y}_{2} {X}_{1}} \\ where & ( 28 ) \\ {X}_{1} = {B}_{11} - \frac{{D}_{11}}{{B}_{11}} {A}_{11} - \frac{{D}_{12}}{{B}_{22}} {A}_{12} \\ {X}_{2} = - \frac{{D}_{11}}{{B}_{11}} {A}_{12} - \frac{{D}_{12}}{{B}_{22}} {A}_{22} \\ {X}_{3} = \frac{{D}_{11}}{{B}_{11}} ( {N}_{x}^{T} + {N}_{x}^{S} ) + \frac{{D}_{12}}{{B}_{22}} ( {N}_{y}^{T} + {N}_{y}^{S} ) \\ and & ( 30 ) \\ {Y}_{1} = - \frac{{D}_{12}}{{B}_{11}} {A}_{11} - \frac{{D}_{22}}{{B}_{22}} {A}_{12} \\ {Y}_{2} = {B}_{22} - \frac{{D}_{12}}{{B}_{11}} {A}_{12} - \frac{{D}_{22}}{{B}_{22}} {A}_{22} \\ {Y}_{3} = \frac{{D}_{12}}{{B}_{11}} ( {N}_{x}^{T} + {N}_{x}^{S} ) + \frac{{D}_{22}}{{B}_{22}} ( {N}_{y}^{T} + {N}_{y}^{S} ) & ( 31 )\end{matrix}$$

Using Equation (10), the thermal resultants are evaluated as:

Nₓ^{T}=N_{y}^{T}=3.71×10⁻⁴hΔT (32)

Mₓ^{T}=−M_{y}^{T}=−1.12×10⁻⁴h²ΔT (33)

With ΔT=20−177=−157° C., we have:

Tₓ^{T}=T_{y}^{T}=−0.0582h (34)

Mₓ^{T}=−M_{y}^{T}=−0.0176h² (35)

Substituting values into Equations (30) and (31) gives:

X₁=58.92h²

X₂=0

X₃=0.0616h²

Y₁=0

Y₂=−58.92h²

Y₃=−0.0616h²

Using the known values to evaluate the strains and curvatures in Equations (26) to (29) one has:

$$\begin{matrix}{ɛ}_{x}^{0} = {ɛ}_{y} = - 0.00147 & ( 39 ) \\ {κ}_{x} = {κ}_{y} = - \frac{0.00242}{h} & ( 40 )\end{matrix}$$

Examination of Equation (40) shows that the curvatures depend on (1/h) where h is the thickness of the layer group. For example, this means that a laminate with stacking sequence of [0/90] has curvatures that are two times smaller than a laminate with a stacking sequence of [0₂/90₂]. The expression [0₂/90₂] refers to a laminate having a first 2 layers laid down at 0 degree, then two other layers laid at 90 degrees on top of the 0 degree layers.

For example, using the value of h=0.130 mm (10.30×10⁻⁴ m) one has:

$${κ}_{x} = {κ}_{y} = - \frac{18.62}{m}$$

Giving a curvature of,

Rₓ=−0.054m=−5.4 cm

R_{y}=0.054m=5.4 cm (42)

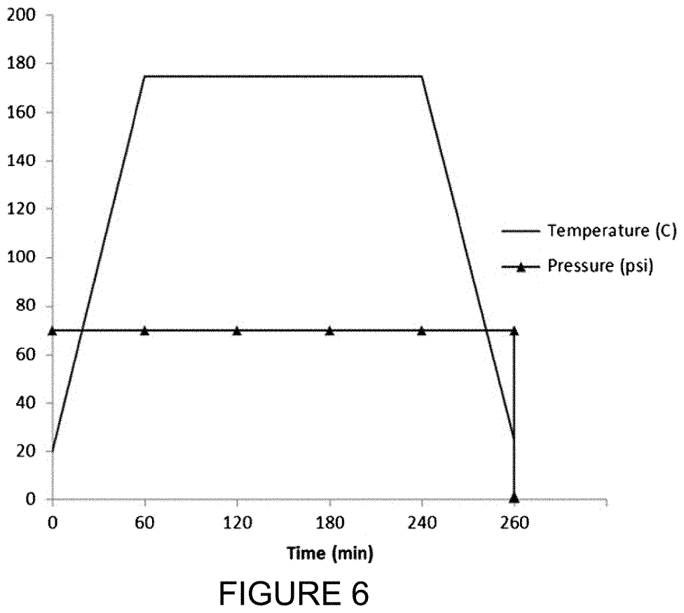

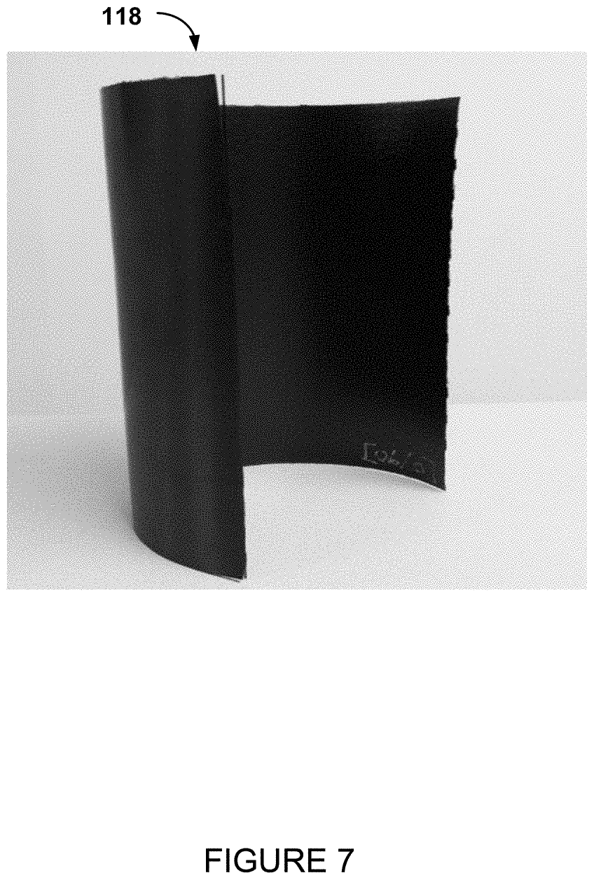

To further illustrate the above example, a sample of carbon/epoxy composites with lay-up sequence [0/90] was produced using an automated fiber placement machine and an autoclave curing. The material used was CYCOM™ 977-2 carbon epoxy prepregs provided by Cytec Solvay Group. The curing temperature was 177° C. Initially a flat stack of prepregs was made. The curing cycle used is shown in FIG. 6. After curing, the laminate becomes curved, as shown in FIG. 7. The radius of curvature of the sample is measured to be 5.9 cm. In this example, the difference between the calculated curvature and the experimental curvature is due to the many assumptions made for the values used in the calculation (5.9 cm vs. 5.4 cm). First is the amount of shrinkage that contributes to the reconfiguration. Also, the results are for one particular type of resin which further depend on the amount of the curing agents. These can have effect on the final result. Secondly the values shown in Table 1 also depend on the particular type of fiber, resin, and volume fraction. Thirdly, the modulus of the resin also changes as the temperature decreases from cure temperature to room temperature. These all can contribute to the validity of the result from the model.

In this example, the model shows that there are two curvatures, Rₓ and R_{y}. However from experiment, only one curvature exists, which is shown by the composite structure 118 in FIG. 7. Whichever curvature is obtained from the model depends on the constraint of the model which favors one curvature over the other. This configuration may be snapped to take up the other curvature.

The above example shows the situation for the unsymmetric laminate with the lay-up sequence of [0/90]. In some embodiments, the number of the 0° and 90° layers may be varied. Table 2 shows the radius of curvatures for different laminates. Note that the calculated radii of curvatures are different from the experimental results due to the assumptions discussed above. The experimental values have a range due to the variation of the radii of curvature from sample to sample, with the same lay-up sequence. For the series of laminates [0/90n], when n increases from 1, the radius becomes smaller when n=2 but increases for values of n more than 2. This is because apart from the different amounts of contractions along different directions, there is also the effect of the change in the location of the neutral axis as the number of layers changes.

TABLE 2
Radius of curvatures for different laminates

| | Radius of curvature | Radius of curvature |
|---|---|---|
| Laminate | calculated (cm) | experimental (cm) |
| 0/90 | 5.4 | 5.6-7.2 |
| 0₂/90₂ | 10.8 | 13.3 |
| 0₃/90₃ | 16.2 | 15.9 |
| 0/90₂ | 4.7 | 5.6-5.7 |
| 0/90₃ | 5.7 | 6.3-6.7 |

In order to further demonstrate the features of the 4D printing process, composite laminates 108 that reconfigure into S-shaped laminates 118 were examined. The lay-ups to produce the S-shape laminates are shown in FIGS. 3A to 3B. An example process for forming the composite laminate 108 for an S-shaped composite structure 118 is as follows:
Step 1: At a first elevation, initially a first layer 301 of 0° fiber orientation is placed on the tool 106 up to a certain length;
Step 2: At the same elevation, a second layer 302 at 90° fiber orientation is then placed overlapping with a portion of the length of the first layer 301;
Step 3: At the second elevation, a third layer 303 at 90° fiber orientation is laid on top of the second layer 302;
Step 4: At the same second elevation, a fourth layer 304 at 0° fiber orientation is placed overlapping with the third layer 303.

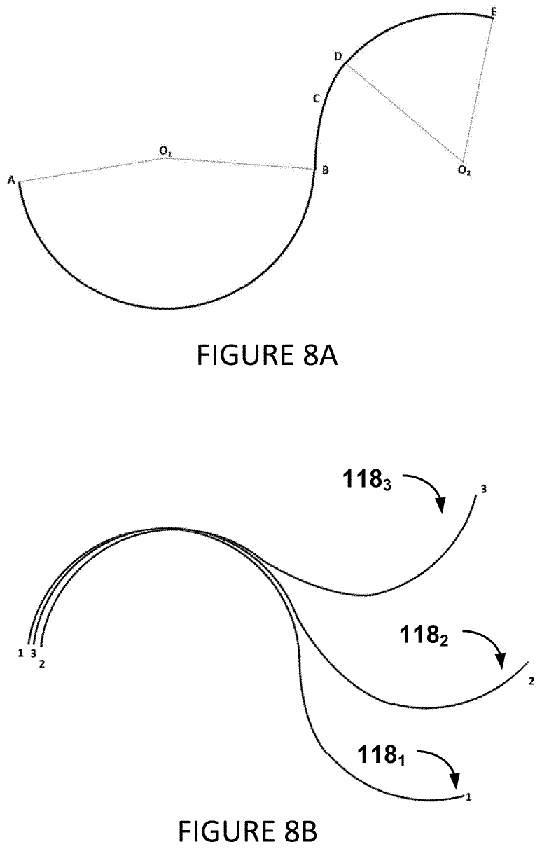

Three composite laminates 108₁, 108₂, 108₃ were made using the above process, as shown in FIG. 4A. The difference between them is the relative length between the left segment and the right segment of the laminate, as shown in FIGS. 3A to 3C. Upon curing and cooling, composite laminates 108₁, 108₂, 108₃ reconfigured to the S-shaped composite structures 118₁, 118₂, 118₃, as shown in FIG. 4B. The curved configurations of the three laminates are traced and are shown in FIG. 8A. Segment AB corresponds to the unsymmetric laminate [0/90] while segment DE corresponds to the unsymmetreic laminate [90/0]. This gives the S shape configuration. The overlapped region BCD is straighter because the lay-up sequence in this segment is [0/90/0]. The edge tracings for the three plates are placed together as shown in FIG. 8B.

The dimensions for the three plates are shown in Table 3. The table shows the radii of curvature at two ends of the S piece. There is variation of the radii of curvature from sample to sample, even though the lay-up sequence is the same [0/90] or [90/0].

TABLE 3
Radii of curvature for three plates

| | O₁A (cm) | O₂E (cm) |
|---|---|---|
| Plate 1 | 5.9 | 5.9 |
| Plate 2 | 7.2 | 7.2 |
| Plate 3 | 6.7 | 6.7 |

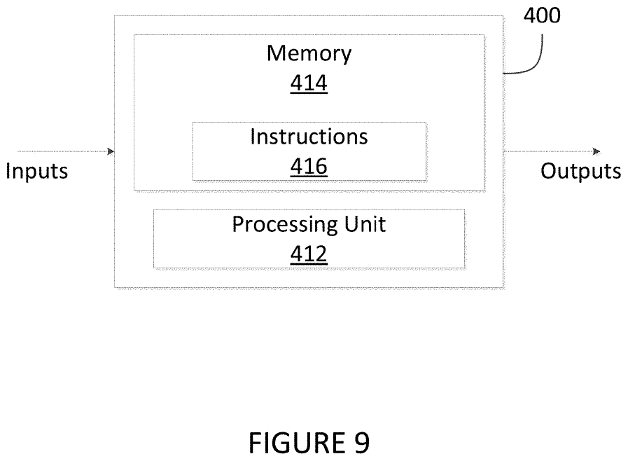

With reference to FIG. 9, the method 200 may be implemented by at least in part by a computing device 400, comprising a processing unit 412 and a memory 414 which has stored therein computer-executable instructions 416. The processing unit 412 may comprise any suitable devices configured to implement the system such that instructions 416, when executed by the computing device 400 or other programmable apparatus, may cause the functions/acts/steps of the method 200 as described herein to be executed. The processing unit 412 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 414 may comprise any suitable known or other machine-readable storage medium. The memory 414 may comprise non-transitory computer readable storage medium, for example, but not limited to, an electronic, magnetic, optical, electromagnetic, infrared, or semiconductor system, apparatus, or device, or any suitable combination of the foregoing. The memory 414 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 414 may comprise any storage means (e.g., devices) suitable for retrievably storing machine-readable instructions 416 executable by processing unit 412.

The methods and systems for 4D printing of composites described herein may be implemented in a high level procedural or object oriented programming or scripting language, or a combination thereof, to communicate with or assist in the operation of a computer system, for example the computing device 400. Alternatively, the methods and systems 4D printing of composites may be implemented in assembly or machine language. The language may be a compiled or interpreted language. Program code for implementing the methods and systems for 4D printing of composites may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems for 4D printing of composites may also be considered to be implemented by way of a non-transitory computer-readable storage medium having a computer program stored thereon. The computer program may comprise computer-readable instructions which cause a computer, or in some embodiments the processing unit 412 of the computing device 400, to operate in a specific and predefined manner to perform the functions described herein.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

By way of a specific and non-limiting example of implementation, the above systems and/or methods may be used to produce composite springs, as described below:

Composite springs are used in many applications. Two typical applications are in leaf springs for automobiles and in prostheses.

Conventional leaf springs are usually made of steel. They consist of either a single leaf or many leaves connected together. Composite springs consist mainly of curved composite laminates. The basic constituent of a composite leaf spring is a curved composite beam. The reason for the selection of composite springs is due to the light weight, high stiffness and good fatigue and corrosion resistances of composites.

The process of manufacturing composite leaf springs is usually Resin Transfer Molding (RTM). The process requires a high precision matched metal mold. Composite preforms are placed snugly inside the mold. Resin is then infused into the dry composite preforms using high pressure. Fibers are usually glass or carbon, and the matrix is usually epoxy.

Typical dimensions of composite leaf springs are shown in Table 4.

TABLE 4
Typical dimensions of composite leaf springs for automotive applications

| Items | Typical dimensions |
|---|---|
| Total length (mm) | 1000 |
| Width (mm) | 50 |
| Arc height (mm) | 188 |
| Radius of curvature (mm) | 950 |
| Thickness of leaf (mm) | 10 |
| Spring constant (N/cm) | 400 |

Besides springs for automotive applications, composite springs have also been used for prostheses. The manufacturing of these prostheses usually need to have a mold with curved configuration similar to that of the final part.

4D printing is a combination of 3D printing together with the reconfiguration of asimple shaped structure into a complex shaped structure. First, layers of materials with special properties are deposited using a method similar to 3D printing. Then the structure is subjected to the application of some activation mechanism such as heat, light, or the absorption of liquid such as water. This activation changes the configuration of the structure into some complex shape, depending on the design. Some of the existing work on regular 4D printing utilizes materials that are soft and do not have high strength or stiffness.

The 4D printing of composites utilizes the concept of regular 4D printing. However 4D printing of composites uses materials made of long fiber embedded in polymeric resins. These are the long continuous fiber reinforced composites. As such the materials used in 4D printing of composites may have good strength, good stiffness, and high fatigue resistance. The method of automated composites manufacturing is used to deposit many flat layers of composites to make stacks. The individual layers have different fiber orientations. Upon curing (application of heat), the resin cures, and serves as shear load transfer medium between the fibers. Upon cooling from the cure temperature down to room temperature, the difference in coefficients of thermal contraction between the different layers will provide the reconfiguration of the shape of the structure. Laminate theory can be used to determine and predict the curvatures created by the reconfiguration.

Radius requirement: The concept of 4D printing of composites can provide structures of complex shapes using only flat molds. For leaf spring applications, Table 4 shows that the curvature of the common springs is about 950 mm. The springs also only have cylindrical curvature. As such, only lay ups containing 0° and 90° fiber orientation need to be considered.

TABLE 5
Properties of composite materials

| Properties | Carbon/epoxy |
|---|---|
| E₁ (GPa) | 155.0 |
| E₂ (GPa) | 12.1 |
| G₁₂(GPa) | 4.4 |
| v₁₂ | 0.248 |
| α₁ (10⁻⁶/C) | −0.018 |
| α₂ (10⁻⁶/C) | 24.3 |
| Longitudinal tensile strength (MPa) | 1500 |
| Longitudinal compression strength (MPa) | 1250 |
| Transverse tensile strength (MPa) | 50 |
| Transverse compressive strength (MPa) | 200 |
| Shear strength (MPa) | 100 |

Using the properties of carbon/epoxy as shown in Table 5, with the assumption of thickness of each layer to be 0.125 mm, and laminate theory, the radii of curvature for different laminates with different stacking sequences can be calculated and are shown in Table 6.

A few laminates were made using carbon/epoxy materials (CYTEC 977-2). The layers were laid on a flat mandrel using an automated fiber placement machine, with a curing temperature of 177° C. After being taken from the autoclave, the radii of the laminates were measured and are shown in Table 6.

There is some difference between the calculated radii and the experimental radii. The reason for this can be due to the uncertainty in the contribution of the chemical shrinkage of the resin during the curing process. The chemical shrinkage tends to reduce the effect of the contraction coefficients and tend to result into large radii of curvature.

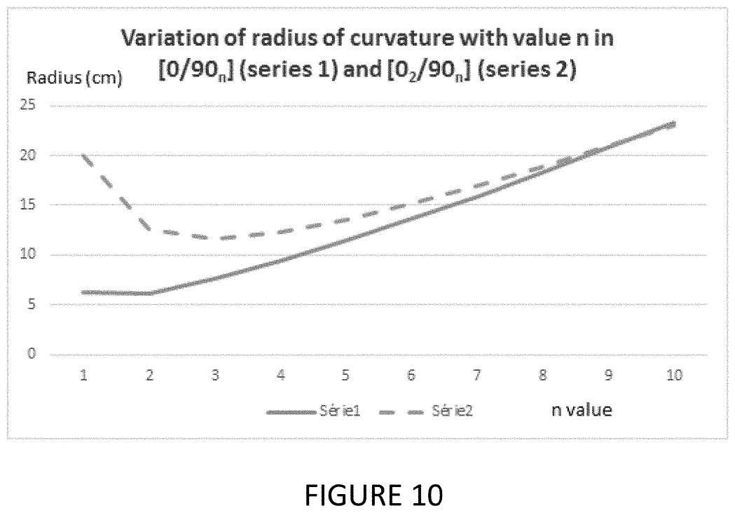

Two main groups of laminates have been considered, namely the [0/90ₙ] laminates and the [0₂/90ₙ] laminates. These were examined to study the effect of adding more layers of 90° on the radii of curvature. FIG. 10 shows the variation of the curvature with respect to the value of n.

It can be seen that for the [0/90ₙ] laminates, as n goes from 1 to 2, there is a reduction in the radius of curvature. After that, as n increases, the radius of curvature increases. For the group of laminates [0₂/90ₙ], as n goes from 1 to 2 to 3, the radius of curvature decreases. After that, as n increases, the radius of curvature increases. This behavior is due to the shifting of the neutral axis toward the 90° layers as the number of these layers increases.

Note that the radius of curvature of laminate [0₂/90₂) is twice that of laminate [0/90]. In fact, it can be stated that the radius of curvature of a laminate is proportional to the thickness of the sub-laminate within the laminate. For example, the radius of curvature of laminate [0₁₆/90₂₄] is twice that of the laminate [0₈/90₁₂], and eight times that of the laminate [0₂/90₃].

From FIG. 10, it can be seen that the [0₂/90ₙ] laminates have larger radius of curvature than the [0/90ₙ] laminate at small n, but as n increases, the curvatures of the two types of laminates approach each other.

In addition, a few thicker laminates were also examined. These were added in order to achieve similar properties with the current leaf springs as shown in Table 4. Among the different laminates, the one with [0₁₆/90₂₄] lay up sequence has a radius of curvature of 93 cm, which is closest to the value of 95 cm shown in Table 4 for current composite springs. As such, this lay up sequence will be selected for experimental evaluation.

TABLE 6
Radii of curvatures, and included angles for laminates with different
stacking sequences

| | | | | | Included |
|---|---|---|---|---|---|
| | | Thick- | Radius of | Radius of | angle 2θₒ |
| | # | ness | curvature | curvature (exp) | radian(°) |
| Laminate | layers | (mm) | R (cm) | (cm) | (G = 30.48 cm) |
| 0/90 | 2 | 0.250 | 6.3 | 5.6-7.2. | 4.87(279) |
| 0/90₂ | 3 | 0.375 | 6.1 | 5.6-6.2 | 5.00(286) |
| 0/90₃ | 4 | 0.500 | 7.6 | 6.3-7.0 | 4.01(230) |
| 0/90₄ | 5 | 0.625 | 9.5 | | 3.22(184) |
| 0/90₅ | 6 | 0.750 | 11.5 | | 2.65(152) |
| 0/90₆ | 7 | 0.875 | 13.7 | | 2.22(127) |
| 0/90₇ | 8 | 1.000 | 15.9 | 14.6-15.9 | 1.92(110) |
| 0/90₈ | 9 | 1.125 | 18.4 | | 1.66(95) |
| 0/90₉ | 10 | 1.250 | 20.8 | | 1.47(84) |
| 0/90₁₀ | 11 | 1.375 | 23.4 | | 1.30(75) |
| 0₂/90 | 3 | 0.375 | 20.1 | | 1.52(87) |
| 0₂/90₂ | 4 | 0.500 | 12.5 | 13.3 | 2.43(139) |
| 0₂/90₃ | 5 | 0.625 | 11.6 | 13.8 | 2.63(151) |
| 0₂/90₄ | 6 | 0.750 | 12.3 | | 2.48(142) |
| 0₂/90₅ | 7 | 0.875 | 13.6 | | 2.25(129) |
| 0₂/90₆ | 8 | 1.000 | 15.2 | | 2.01(115) |
| 0₂/90₇ | 9 | 1.125 | 17.0 | | 1.79(103) |
| 0₂/90₈ | 10 | 1.250 | 18.9 | | 1.61(92) |
| 0₂/90₉ | 11 | 1.375 | 21.0 | | 1.45(83) |
| 0₂/90₁₀ | 12 | 1.500 | 23.1 | | 1.32(76) |
| 0₈/90₁₂ | 20 | 2.500 | 46.4 | 60 | 0.65(38) |
| 0₁₆/90₂₄ | 40 | 5.000 | 93 | 105 | 0.33(19) |
| 0₂₄/90₃₆ | 60 | 7.500 | 139 | | 0.22(13) |

Stiffness requirement: The stiffness of the curved beam depends on three elements. One is section modulus, which depends on the thickness and composition of the layers. The section modulus can be represented by the equivalent bending stiffness <El>. The second element is the radius of curvature, and the third element is the length of the beam.

Bending section modulus: The calculation of <El> follows the sum of the contributions from the different layers and their positions in the stacking sequence. The bending section modulus of the laminate [0/90₄] is shown below. The center of the coordinate axis z is taken to be the mid plane of the laminate:

<El>≤ 1/12b(3h)³E₉₀+ 1/12bh³E₉₀+bh(2h)²E₉₀+ 1/12bh³Eₒ+bh(2h)²Eₒ (101)

Where <El> represents the equivalent bending stiffness of the section. b: is the width of the beam. h: is the thickness of each layer. E₉₀ is the modulus of the 90° layer. Eₒ is the modulus of the 0° layer.

Collecting terms, equation (101) gives:

$$< EI >= \frac{{bh}^{3}}{12} ( 76 {E}_{90} + 49 {E}_{o} ) \qquad ( 102 )$$

From table 5, the ratio for E₂/E₁ is (12.1 GPa/155 GPa=0.078). Using this value in equation (102) gives:

$$< EI >= \frac{{E}_{o} {bh}^{3}}{12} ( 54.9 ) \qquad ( 103 )$$

Following the same procedure, the expression for other types of laminates can be obtained. For laminates of type [0/90ₙ]:

$$< EI >= \frac{{bh}^{3}}{12} {E}_{90} ( {n}^{3} + 3 n ) + \frac{{bh}^{3}}{12} {E}_{o} ( 1 + 3 {n}^{2} ) \qquad ( 104 )$$

For laminates of type [0₂/90ₙ]:

$$< EI >= \frac{{bh}^{3}}{12} {E}_{90} ( {n}^{3} + 12 n ) + \frac{{bh}^{3}}{12} {E}_{o} ( 8 + 6 {n}^{2} ) \qquad ( 105 )$$

TABLE 7
Stiffness and spring constant for different laminates (Eₒbh³/12 = 1.92 × 10⁻³ Nm²)

| | | | | | Spring | |
|---|---|---|---|---|---|---|
| | | | | | constant | |
| | | | Normalized | | (N/cm) | Spring |
| | # | | <EI>: | Half included | (12″ long | constant |
| Laminate | layers | R (cm) | <EI>/(Eₒbh³/12) | angle θₒ(rad) | sample) | (exp) (N/cm) |
| 0/90 | 2 | 6.3 | 4.3 | 2.44 | | |
| 0/90₂ | 3 | 6.1 | 14.1 | 2.50 | | |
| 0/90₃ | 4 | 7.6 | 30.8 | 2.01 | | |
| 0/90₄ | 5 | 9.5 | 54.9 | 1.61 | | |
| 0/90₅ | 6 | 11.5 | 86.9 | 1.33 | 2.2 | |
| 0/90₆ | 7 | 13.7 | 127.3 | 1.11 | 2.8 | |
| 0/90₇ | 8 | 15.9 | 176.3 | 0.96 | 3.6 | 5.0 |
| 0/90₈ | 9 | 18.4 | 234.8 | 0.88 | 3.9 | |
| 0/90₉ | 10 | 20.8 | 303 | 0.74 | 5.4 | |
| 0/90₁₀ | 11 | 23.4 | 381.3 | 0.65 | 6.9 | |
| 0₂/90 | 3 | 20.1 | 15.0 | 0.76 | 2.8 | |
| 0₂/90₂ | 4 | 12.5 | 34.5 | 1.22 | 4.2 | |
| 0₂/90₃ | 5 | 11.6 | 66.9 | 1.32 | 4.9 | |
| 0₂/90₄ | 6 | 12.3 | 112.7 | 1.24 | 4.3 | |
| 0₂/90₅ | 7 | 13.6 | 172.4 | 1.13 | 3.8 | |
| 0₂/90₆ | 8 | 15.2 | 246.5 | 1.01 | 5.0 | |
| 0₂/90₇ | 9 | 17.0 | 335.3 | 0.90 | 6.5 | |
| 0₂/90₈ | 10 | 18.9 | 439.4 | 0.80 | 8.5 | |
| 0₂/90₉ | 11 | 21.0 | 559.2 | 0.73 | 10.2 | |
| 0₂/90₁₀ | 12 | 23.1 | 695.4 | 0.66 | 12.6 | 11.0 |
| 0₈/90₁₂ | 20 | 46.4 | 4282.5 | 0.33 | 71.7 | |
| 0₁₆/90₂₄ | 40 | 93 | 34253 | 0.17 | 509 | 486 |
| 0₁₆/90₂₄ | 40 | 93 | 34253 | 0.34 | 64.6 | 60 |
| (60.96 cm | | | | | | |
| long) | | | | | | |
| 0₂₄/90₃₆ | 60 | 139 | 115603 | 0.11 | 1838 | |

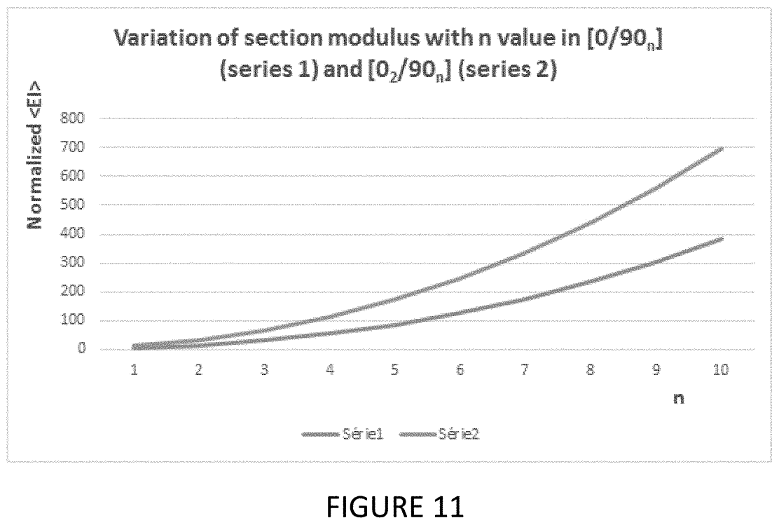

Values for <El> for different laminates were calculated and shown in Table 7. FIG. 11 shows the variation of the section modulus for laminates with different stacking sequences. It can be seen that as n increases, the laminate [0₂/90ₙ] has faster increasing bending modulus than the [0/90ₙ] laminates. It can also be seen that a laminate with stacking sequence [0_{αm}/90_{αn}] would have the bending modulus <El> that is α³ times the bending modulus of laminate with stacking sequence [0ₘ/90ₙ]. For example, the laminate with stacking sequence [0₁₆/90₂₄] has <El> that is 8³ (or 512) times the <El> of laminate [0₂/90₃].

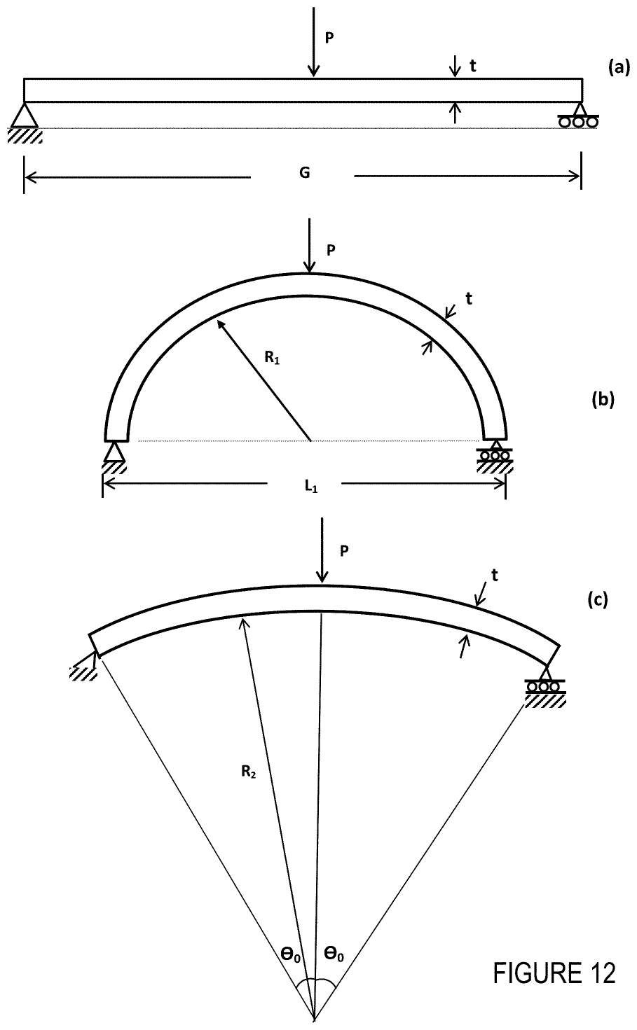

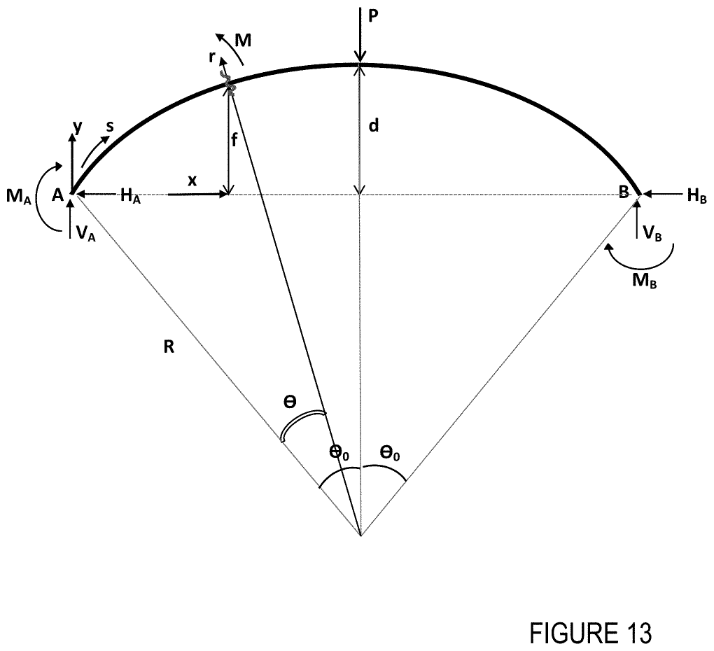

Effect of length and radius of curvature on bending stiffness: The bending stiffness of the beam depends not only on the section modulus <El> but also on the length and radius of curvature of the beam. FIG. 12 shows the comparison between three configurations, where beams of the same lengths but different radii of curvature are shown. For the purpose of comparison, assuming that all beams have the same length G (different spans L), the same load P, and the same boundary conditions. For the case of curved beams, there is a relation between the radius R, the length G, the height d (FIG. 13), and the included angle θₒ.

The lay up sequence will determine the radius of curvature R. The combination of G and R can be used to determine the span length L, the included angle 2θₒ, and the height d, via the following relations:

$${θ}_{o} = \frac{G}{2 R} \qquad ( 106 )$$

Values for the included angle (2θ₀) are calculated for spring of 12 inch (30.48 cm) long and are shown in Table 6.

The span L is given as:

L=2R sin θₒ (107)

And for the height d

d=R(1−cos θₒ) (108)

FIG. 12, part a, shows the situation of a straight beam with span L=G, subjected to simply supported boundary conditions, and mid point loading. The displacement at mid length due to the load P is given as (assume isotropic material):

$${δ}_{1} = \frac{{PG}^{3}}{48 EI} \qquad ( 109 )$$

FIG. 12, part b, shows the situation of a curved beam (half circle with radius R) with the same length G, but with different span L₁, also subjected to a mid length load P. FIG. 12, part c, shows the situation of a curved beam with larger radius than the case in part b. It is of interest to determine the load/deflection relations for the cases of part b and c.

FIG. 13 shows the parameters for analysis for the case of part b and c (note that b is a special case of c). In this figure, all reactions at the support points are shown. In the case of simply supported beams, M_{A}=M_{B}=H_{A}=0.

Let s be the coordinate along the length of the beam, the moment curvature relation can be written as:

$$\frac{{d}^{2} r}{{ds}^{2}} = \frac{M}{EI} \qquad ( 110 )$$

where r is the radial displacement of the beam.

This can be shown to be:

$$\frac{{d}^{2} r}{d {θ}^{2}} = \frac{{R}^{2} [ {V}_{A} R [ sin {θ}_{o} - sin ( {θ}_{o} - θ ) ] ]}{EI} \qquad ( 111 )$$

Where V_{A} is the reaction at the left end boundary. By equilibrium, it can be shown that V_{A}=P/2.

Integrating gives:

$$\frac{dr}{d θ} = \frac{{PR}^{3} [ θ sin {θ}_{o} - cos ( {θ}_{o} - θ ) ] ]}{2 EI} + {C}_{1} \qquad ( 112 )$$

(112)

Integrating again gives:

$$r = \frac{{PR}^{3} [ \frac{{θ}^{2}}{2} sin {θ}_{o} + sin ( {θ}_{o} - θ ) ]}{2 EI} + {C}_{1} θ + {C}_{2} \qquad ( 113 )$$

(113)

At θ=0, r=0,

$${C}_{2} = - \frac{{PR}^{3}}{2 EI} sin {θ}_{o}$$

At θ=θₒ, dr/dθ=0, so:

$${C}_{1} = \frac{{PR}^{3} [ 1 - {θ}_{o} sin {θ}_{o} ]}{2 EI}$$

$$And$$

$$r = \frac{{PR}^{3} [ [ \frac{{θ}^{2}}{2} sin {θ}_{o} + sin ( {θ}_{o} - θ ) - {θθ}_{o} sin {θ}_{o} + θ - sin {θ}_{o} ] ]}{2 EI} \qquad ( 114 )$$

(114)

At θ=θₒ, the displacement is:

$${r}_{o} = \frac{{PR}^{3} [ [ - \frac{{θ}_{o}^{2}}{2} sin {θ}_{o} + {θ}_{o} - sin {θ}_{o} ] ]}{EI} \qquad ( 115 )$$

(115)

For θₒ=π/2,

$${r}_{o} = \frac{{PR}^{3} [ [ - \frac{{π}^{2}}{8} + \frac{π}{2} - 1 ] ]}{EI} = 0.337 \frac{{PR}^{3}}{EI} \qquad ( 116 )$$

The spring constant can be defined as the ratio of load over displacement P/δ.

From equation (116), we have:

$$\frac{P}{{δ}_{curved}} = \frac{EI}{0.337 {R}^{3}} \qquad ( 117 )$$

For a straight beam with the same length as the curved beam (L=πR), equation (119) can be used to determine the spring constant for the straight beam:

$$\frac{P}{{δ}_{straight}} = \frac{48 EI}{{π}^{3} {R}^{3}} = \frac{EI}{0.64 {R}^{3}} \qquad ( 118 )$$

As such, for beams with similar length subjected to similar loading and boundary conditions, curved beams are stiffer than straight beams.

$$\frac{P}{δ} = \frac{EI}{{R}^{3} ( {θ}_{o} - sin {θ}_{o} - \frac{{θ}_{o}^{2}}{2} sin {θ}_{o} )} \qquad ( 119 )$$

Equation (115) can be rewritten to evaluate the spring constant:

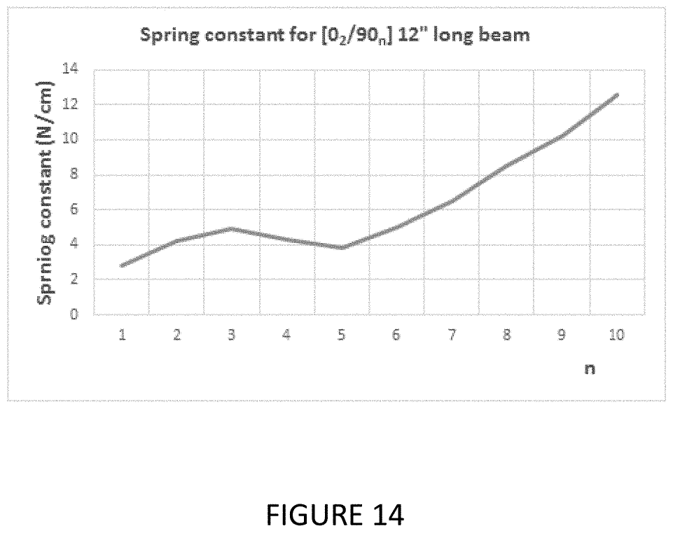

Using equation (119), values of the spring constants for a few laminates are calculated and shown in Table 7. The variations of the spring constant with the values of n for laminates of type [0₂/90ₙ] are shown in FIG. 14.

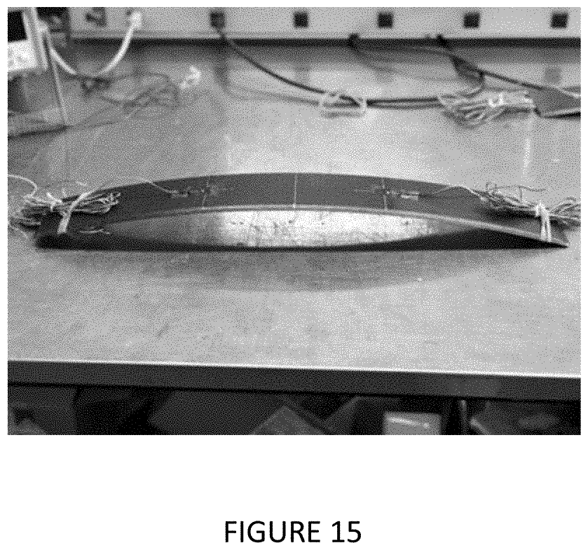

Experimental values: In order to validate the above calculations, two example springs were made and tested. Both springs have the lay up sequence of [0₁₆/90₂₄], made of carbon/epoxy, CYTEC 977-2. Both have width of 3 inch (7.62 cm). One has a length of 12 inch (30.48 cm) and the other has a length of 24 inch (60.96 cm). The two samples were made using automated fiber placement machine at Concordia Center for Composites. The samples were cured in an autoclave. The flat stacks of the layers become curved as shown in FIG. 15. The 0° layers are on the convex side and the 90° layers are on the concave side. The curvatures of the sample were measured to be 105 cm as shown in Table 6.

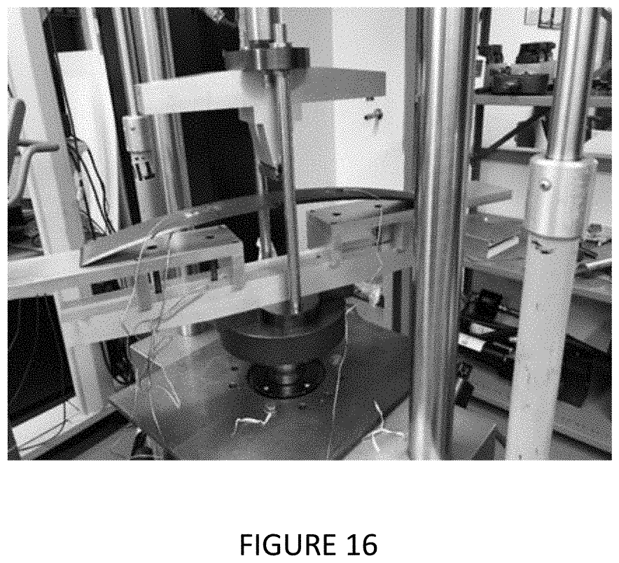

Strain gages were placed onto the samples, two on the convex side and one on the concave side. The two gages on the convex side are located at 4 inch (10.16 cm) from the mid length of the beam. The gage on the concave side is located at the same distance from the mid length. The samples were placed in an MTS machine for 3-point bending test as shown in FIG. 16.

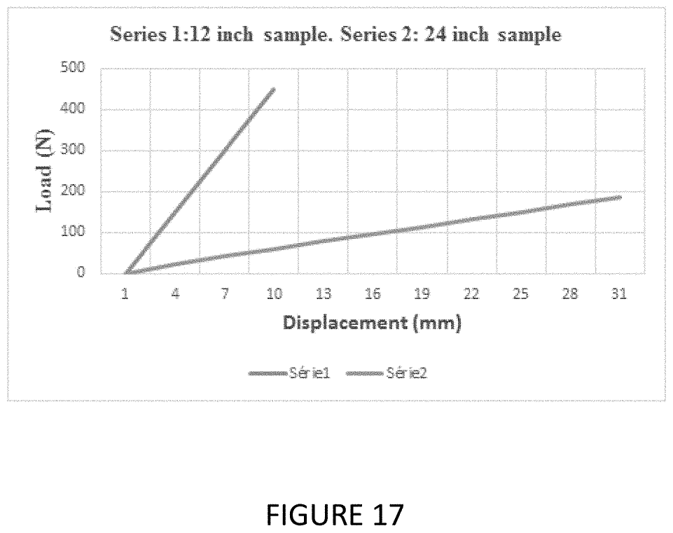

In the static test, the relation between the load and deformation for two types of samples (short and long) are shown in FIG. 17.

The spring constant (load versus displacement) is 60 N/cm for the short sample and about 48.6 N/mm for the long sample. In addition two more samples were made and tested. These are laminates [0/90₇] and [0₂/90₁₀]. These spring constants are shown in Table 7. In comparison with the calculate values, reasonable agreement is obtained.

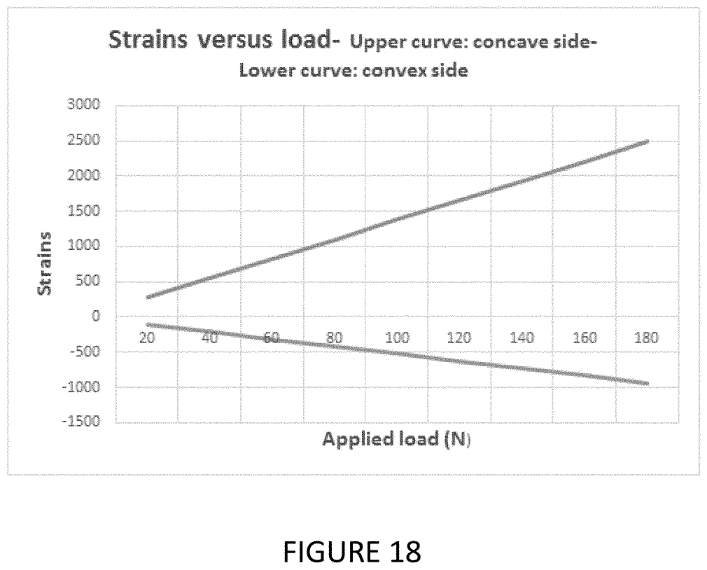

The convex side of the sample exhibits compressive strains while the concave side exhibits tensile strains. For the long sample, FIG. 18 shows the load versus strain curves for two strain gages placed at the same length position, but one on the convex side and the other on the concave side. It can be seen that for the same longitudinal position, the magnitude of the compressive strain on the convex side is smaller than the magnitude of the tensile strain on the concave side. At 150 N, the convex side shows −780 με whereas the concave side shows 2030 με. The load versus strain curve for the short sample (concave side) was also obtained. The short sample is stiffer than the long sample. The load can go up to 180N to give a displacement of 30 cm and a strain of 3500 με.

Strength requirement: Under loading, the configuration of the composite spring is similar to that of FIG. 12, part c. For a lay up sequence such as [0₁₆/90₂₄], the upper layers are the 0° layers and the lower layers are the 90° layers. For durability, it is necessary that the stresses developed during loading does not exceed the strength.

The curved laminate as shown in FIG. 12, part c, was subjected to residual stresses due to the difference in coefficients of thermal contraction in the different layers during cooling from the cure temperature. Analysis can be done to determine these residual stresses. Analysis can also be done to determine the stresses due to mechanical loading as in FIG. 12, part c.

Residual stresses due to cooling from cure temperature: For a laminate subjected to a temperature gradient of ΔT, the relation between the thermal stress/moment resultants and strains and curvatures are:

$$[ \begin{matrix}{N}_{x}^{T} \\ {N}_{y}^{T} \\ {N}_{xy}^{T} \\ {M}_{x}^{T} \\ {M}_{y}^{T} \\ {M}_{xy}^{T}\end{matrix} ] = [ \begin{matrix}{A}_{11} & {A}_{12} & {A}_{16} & {B}_{11} & {B}_{12} & {B}_{16} \\ {A}_{12} & {A}_{22} & {A}_{26} & {B}_{12} & {B}_{22} & {B}_{26} \\ {A}_{16} & {A}_{26} & {A}_{66} & {B}_{16} & {B}_{26} & {B}_{66} \\ {B}_{11} & {B}_{12} & {B}_{16} & {D}_{11} & {D}_{12} & {D}_{16} \\ {B}_{12} & {B}_{22} & {B}_{26} & {D}_{12} & {D}_{22} & {D}_{26} \\ {B}_{16} & {B}_{26} & {B}_{66} & {D}_{16} & {D}_{26} & {D}_{66}\end{matrix} ] [ \begin{matrix}{ɛ}_{x}^{o} \\ {ɛ}_{y}^{o} \\ {γ}_{xy}^{o} \\ {κ}_{x} \\ {κ}_{Y} \\ {κ}_{xy}\end{matrix} ] \qquad ( 120 )$$

For the case of cross ply laminates, it can be shown that A₁₆=A₂₆=B₁₂=B₁₆=B₂₆=D₁₆=D₂₆=0. Equation (120) can be shown to consist of two decoupled equations, one containing the x and y components and the other containing the xy component. For the x and y components only, we have:

$$[ \begin{matrix}{N}_{x}^{T} \\ {N}_{y}^{T} \\ {M}_{x}^{T} \\ {M}_{y}^{T}\end{matrix} ] = [ \begin{matrix}{A}_{11} & {A}_{12} & {B}_{11} & 0 \\ {A}_{12} & {A}_{22} & 0 & {B}_{22} \\ {B}_{11} & 0 & {D}_{11} & {D}_{12} \\ 0 & {B}_{22} & {D}_{12} & {D}_{22}\end{matrix} ] [ \begin{matrix}{ɛ}_{x}^{o} \\ {ɛ}_{y}^{o} \\ {κ}_{x} \\ {κ}_{y}\end{matrix} ] \qquad ( 121 )$$

Inverting yields:

$$[ \begin{matrix}{ɛ}_{x}^{o} \\ {ɛ}_{y}^{o} \\ {κ}_{x} \\ {κ}_{y}\end{matrix} ] = [ \begin{matrix}{a}_{11} & {a}_{12} & {b}_{11} & {b}_{12} \\ {a}_{12} & {a}_{22} & {b}_{21} & {b}_{22} \\ {b}_{11} & {b}_{12} & {d}_{11} & {d}_{12} \\ {b}_{21} & {b}_{22} & {d}_{12} & {d}_{22}\end{matrix} ] [ \begin{matrix}{N}_{x}^{T} \\ {N}_{y}^{T} \\ {M}_{x}^{T} \\ {M}_{y}^{T}\end{matrix} ] \qquad ( 122 )$$

The stresses at any particular point is given as:

$$[ \begin{matrix}{σ}_{x}^{T} \\ {σ}_{y}^{T}\end{matrix} ] = [ \begin{matrix}\overline{{Q}_{11}} & \overline{{Q}_{12}} \\ \overline{{Q}_{12}} & \overline{{Q}_{22}}\end{matrix} ] [ \begin{matrix}{ɛ}_{x}^{oT} + z {κ}_{x}^{oT} - {α}_{x} Δ T \\ {ɛ}_{y}^{oT} + z {κ}_{y}^{oT} - {α}_{y} Δ T\end{matrix} ] \qquad ( 123 )$$

Where

$$\begin{matrix}{α}_{x} = {α}_{1} {m}^{2} + {α}_{2} {n}^{2} {α}_{y} = {α}_{1} {n}^{2} + {α}_{2} {m}^{2} & ( 124 ) \\ {N}_{x}^{T} = {\int }_{- \frac{H}{2}}^{\frac{H}{2}} ( \overline{{Q}_{11}} {α}_{x}^{T} + \overline{{Q}_{12}} {α}_{y}^{T} + \overline{{Q}_{16}} {α}_{xy}^{T} ) Δ T dz & ( 125 a ) \\ {N}_{y}^{T} = {\int }_{- \frac{H}{2}}^{\frac{H}{2}} ( \overline{{Q}_{12}} {α}_{x}^{T} + \overline{{Q}_{22}} {α}_{y}^{T} + \overline{{Q}_{26}} {α}_{xy}^{T} ) Δ T dz & ( 125 b ) \\ {M}_{x}^{T} = {\int }_{- \frac{H}{2}}^{\frac{H}{2}} ( \overline{{Q}_{11}} {α}_{x}^{T} + \overline{{Q}_{12}} {α}_{y}^{T} + \overline{{Q}_{16}} {α}_{xy}^{T} ) Δ Tzdz & ( 125 c ) \\ {M}_{y}^{T} = {\int }_{- \frac{H}{2}}^{\frac{H}{2}} ( \overline{{Q}_{12}} {α}_{x}^{T} + \overline{{Q}_{22}} {α}_{y}^{T} + \overline{{Q}_{26}} {α}_{xy}^{T} ) Δ Tzdz & ( 125 d )\end{matrix}$$

Stresses due to mechanical load: Since the only mechanical load is the bending moment M_{z} caused by the load P, the moment resultant-strain relation can be written as:

$$[ \begin{matrix}0 \\ 0 \\ {M}_{z} \\ 0\end{matrix} ] = [ \begin{matrix}{A}_{11} & {A}_{12} & {B}_{11} & 0 \\ {A}_{12} & {A}_{22} & 0 & {B}_{22} \\ {B}_{11} & 0 & {D}_{11} & {D}_{12} \\ 0 & {B}_{22} & {D}_{12} & {D}_{22}\end{matrix} ] [ \begin{matrix}{ɛ}_{x}^{o} \\ {ɛ}_{y}^{o} \\ {κ}_{x} \\ {κ}_{y}\end{matrix} ] \qquad ( 126 )$$

Inverting yields:

$$[ \begin{matrix}{ɛ}_{x}^{o} \\ {ɛ}_{y}^{o} \\ {κ}_{x} \\ {κ}_{y}\end{matrix} ] = [ \begin{matrix}{a}_{11} & {a}_{12} & {b}_{11} & {b}_{12} \\ {a}_{12} & {a}_{22} & {b}_{21} & {b}_{22} \\ {b}_{11} & {b}_{12} & {d}_{11} & {d}_{12} \\ {b}_{21} & {b}_{22} & {d}_{12} & {d}_{22}\end{matrix} ] [ \begin{matrix}0 \\ 0 \\ {M}_{z} \\ 0\end{matrix} ] \qquad ( 127 )$$

Based Kirchhoff assumption, the strain at any point across the thickness of the laminate can be written as:

εₓ=εₓ^{o}zkₓ=(b₁₁+d₁₁z)M_{z} (128)

The neutral axis is located at:

$$z = - \frac{{b}_{11}}{{d}_{11}} \qquad ( 129 )$$

The stresses due to mechanical load at any point can be given as

$$[ \begin{matrix}{σ}_{x}^{M} \\ {σ}_{y}^{M}\end{matrix} ] = [ \begin{matrix}\overline{{Q}_{11}} & \overline{{Q}_{12}} \\ \overline{{Q}_{12}} & \overline{{Q}_{22}}\end{matrix} ] [ \begin{matrix}{ɛ}_{x}^{oM} + z {κ}_{x}^{oM} \\ {ɛ}_{y}^{oM} + z {κ}_{y}^{oM}\end{matrix} ] \qquad ( 130 )$$

Stresses due to combination of residual stresses and mechanical loads: The stresses due to the combination of thermal residual stresses and mechanical loads can be obtained using both equations (123) and (130):

$$[ \begin{matrix}{σ}_{x}^{C} \\ {σ}_{y}^{C}\end{matrix} ] = [ \begin{matrix}\overline{{Q}_{11}} & \overline{{Q}_{12}} \\ \overline{{Q}_{12}} & \overline{{Q}_{22}}\end{matrix} ] [ \begin{matrix}{ɛ}_{x}^{oT} + z {κ}_{x}^{oT} - {α}_{x} Δ T + {ɛ}_{x}^{oM} + z {κ}_{x}^{oM} \\ {ɛ}_{y}^{oT} + z {κ}_{y}^{oT} - {α}_{y} Δ T + {ɛ}_{y}^{oM} + z {κ}_{y}^{oM}\end{matrix} ] \qquad ( 131 )$$

Example: The particular case of the laminate [0₁₆/90₂₄] will be examined here. For this, using the properties in Table 5, one has:

Q₁₁=155.7 GPa Q₁₂=3.02 GPa Q₂₂=12.16 GPa Q₆₆=4.40 GPa

For 0° layer:

Q̅₁̅₁̅=155.7 GPa Q̅₁̅₂̅=3.02 GPa Q̅₂̅₂̅=12.16 GPa Q̅₆̅₆̅=4.40 GPa Q̅₁̅₆̅=0 GPa Q̅₂̅₆̅=0 GPa

For the 90° layer:

Q̅₁̅₁̅=12.16 GPa Q̅₁̅₂̅=3.02 GPa Q̅₂̅₂̅=12.16 GPa Q̅₆̅₆̅=4.40 GPa Q̅₁̅₆̅=0 GPa Q̅₂̅₆̅=0 GPa

For a laminate with a stacking sequence [0₂ₘ/90₂ₙ], (m<n), the components of the stiffness can be shown to be:

$$\begin{matrix}{A}_{11} = 2 h [ \overline{{( {Q}_{11} )}_{o}} m + {( \overline{{Q}_{11}} )}_{90} n ] \\ {A}_{22} = 2 h [ \overline{{( {Q}_{22} )}_{o}} m + {( \overline{{Q}_{22}} )}_{90} n ] \\ {A}_{12} = 2 h [ \overline{{( {Q}_{12} )}_{o}} m + {( \overline{{Q}_{12}} )}_{90} n ] = 2 h ( m + n ) \overline{{Q}_{12}} & ( 132 ) \\ {B}_{11} = 2 {mnh}^{2} [ {( \overline{{Q}_{11}} )}_{90} - {( \overline{{Q}_{11}} )}_{o} ] \\ {B}_{22} = 2 {mnh}^{2} [ {( \overline{{Q}_{22}} )}_{90} - {( \overline{{Q}_{22}} )}_{o} ] = - {B}_{11} & ( 133 ) \\ {D}_{11} = \frac{{h}^{3}}{3} [ {( \overline{{Q}_{11}} )}_{o} ( 6 {mn}^{2} + 2 {m}^{3} ) + {( \overline{{Q}_{11}} )}_{90} ( 6 {m}^{2} n + 2 {n}^{3} ) ] \\ {D}_{22} = \frac{{h}^{3}}{3} [ {( \overline{{Q}_{22}} )}_{o} ( 6 {mn}^{2} + 2 {m}^{3} ) + {( \overline{{Q}_{22}} )}_{90} ( 6 {m}^{2} n + 2 {n}^{3} ) ] \\ {D}_{12} = \frac{2}{3} {h}^{3} \overline{{Q}_{12}} ( {m}^{3} + {n}^{3} + 3 {m}^{2} n + 3 {mn}^{2} ) & ( 134 )\end{matrix}$$

Then,

A₁₁=3.48×10⁸ N/m A₁₂=0.15×10⁸ N/m A₂₂=4.91×10⁸ N/m

B₁₁=−4.31×10⁵ N B₂₂=−B₁₁=4.31×10⁵ N

D₁₁=868 Nm D₂₂=880 Nm D₁₂=31.4 Nm

Strains due to thermal loads: Equation (121) becomes:

$$[ \begin{matrix}{N}_{x}^{T} \\ {N}_{y}^{T} \\ {M}_{x}^{T} \\ {M}_{y}^{T}\end{matrix} ] = [ \begin{matrix}3.48 \times {10}^{8} & 0.15 \times {10}^{8} & - 4.31 \times {10}^{5} & 0 \\ 0.15 \times {10}^{8} & 4.91 \times {10}^{8} & 0 & 4.31 \times {10}^{5} \\ - 4.31 \times {10}^{5} & 0 & 868 & 31.4 \\ 0 & 4.31 \times {10}^{5} & 31.4 & 880\end{matrix} ] [ \begin{matrix}{ɛ}_{x}^{o} \\ {ɛ}_{y}^{o} \\ {κ}_{x} \\ {κ}_{y}\end{matrix} ] \qquad ( 135 )$$

Using Mathematica to invert, one has:

$$[ \begin{matrix}{ɛ}_{x}^{o} \\ {ɛ}_{y}^{o} \\ {κ}_{x} \\ {κ}_{y}\end{matrix} ] = {10}^{- 3} [ \begin{matrix}7.5 \times {10}^{- 6} & - 1.97 \times {10}^{- 7} & 3.7 \times {10}^{- 3} & - 3.63 \times {10}^{- 5} \\ - 1.97 \times {10}^{- 7} & 3.6 \times {10}^{- 6} & - 3.42 \times {10}^{- 5} & - 1.76 \times {10}^{- 3} \\ 3.7 \times {10}^{- 3} & - 3.42 \times {10}^{- 5} & 3.01 & - 9.0 \times {10}^{- 2} \\ - 3.63 \times {10}^{- 5} & - 1.76 \times {10}^{- 3} & - 9.0 \times {10}^{- 2} & 2.0\end{matrix} ] [ \begin{matrix}{N}_{x}^{T} \\ {N}_{y}^{T} \\ {M}_{x}^{T} \\ {M}_{y}^{T}\end{matrix} ] \qquad ( 136 )$$

The thermal stress resultants and moment resultants are calculated using equations (125) to be:

$${N}_{x}^{T} = 8.22 \times {10}^{6} h Δ T {N}_{y}^{T} = 6.42 \times {10}^{6} h Δ T \\ {M}_{x}^{T} = 8.64 \times {10}^{7} \frac{{h}^{2}}{2} Δ T {M}_{y}^{T} = - 8.64 \times {10}^{7} \frac{{h}^{2}}{2} Δ T \qquad ( 137 )$$

Using the value of h=0.125 mm and ΔT=20−177=−157° C. into equation (137) gives the following values:

Nₓ^{T}=−161,318 N/m N_{y}^{T}=−126,008 N/m

Mₓ^{T}=−106 N M_{y}^{T}=106 N (138)

Substituting into equation (136) gives

εₓ^{o}=−1.36×10⁻³

kₓ=−0.921 (139)

The strain at any point across the thickness of the laminate is given as:

εₓ=εₓ^{o}+zκₓ or

εₓ=−1.36×10⁻³−0.921z (140)

The neutral surface is where the strain is equal to 0:

$$z = \frac{1.36 \times {10}^{- 3}}{- 0.921} = - 1.472 mm$$

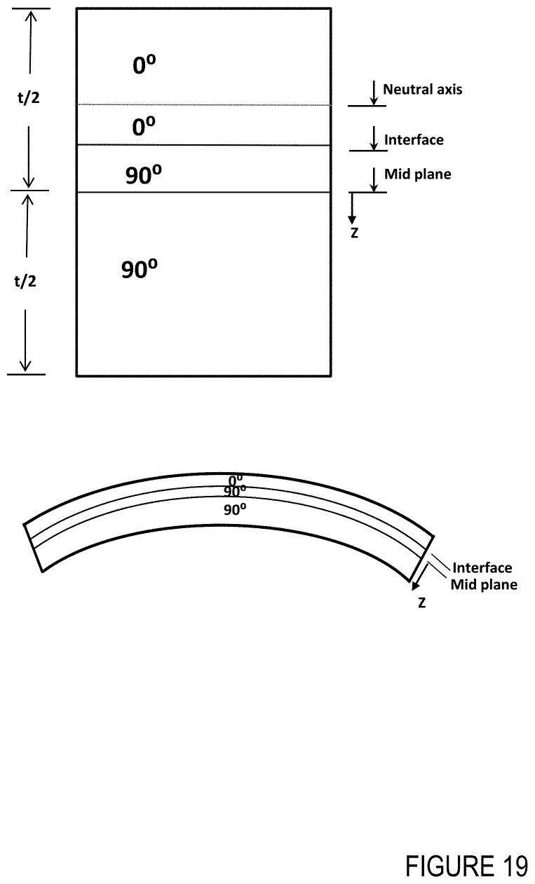

This is located about 12 layers above the mid plane, and is within that 0° layers. Location of the neutral surface is as shown in FIG. 19.

Using equation (140), the strains at different critical locations are:

| Position | Strains (μϵ) |
|---|---|
| Concave surface (90° layers) (z = 2.5 mm) | −3660 |
| Convex surface (0° layers) (z = −2.5 mm) | 947 |
| Interface between 90° and 0° layers, z = −0.5 | −946 |
| mm | |

It can be seen that all of the 90° layers are under compressive strains, while some of the 0° layers (about 10 layers) are under compressive strains, while the rest (about 6 layers) are under tensile strain.

Strains due to mechanical load: Equation (136) can be used to write the strain-stress resultant for the case of mechanical load as:

$$[ \begin{matrix}{ɛ}_{x}^{o} \\ {ɛ}_{y}^{o} \\ {κ}_{x} \\ {κ}_{y}\end{matrix} ] = {10}^{- 3} [ \begin{matrix}7.5 \times {10}^{- 6} & - 1.97 \times {10}^{- 7} & 3.7 \times {10}^{- 3} & - 3.63 \times {10}^{- 5} \\ - 1.97 \times {10}^{- 7} & 3.6 \times {10}^{- 6} & - 3.42 \times {10}^{- 5} & - 1.76 \times {10}^{- 3} \\ 3.7 \times {10}^{- 3} & - 3.42 \times {10}^{- 5} & 3.01 & - 9.0 \times {10}^{- 2} \\ - 3.63 \times {10}^{- 5} & - 1.76 \times {10}^{- 3} & - 9.0 \times {10}^{- 2} & 2.0\end{matrix} ] [ \begin{matrix}0 \\ 0 \\ {M}_{z} \\ 0\end{matrix} ]$$

The strain at any point can be written as:

εₓ=(3.7×10⁻⁶+0.003z)M_{z} (141)

Combining equations (140) and (141), the combined strains due to residual thermal stresses and applied mechanical load is:

εₓ=−1.36×10⁻³+3.7×10⁻⁶M_{z}+(−0.921+0.003M_{z})z (142)

The neutral axis corresponds to when the strain is zero, given by:

$${z}_{n} = \frac{1.36 \times {10}^{- 3} - 3.7 \times {10}^{- 6} {M}_{z}}{- 0.921 + 0.003 {M}_{z}} \qquad ( 143 )$$

Based on FIG. 12, part c, the bending moment at a section of the beam depends on the location of the beam. As such, the neutral axis would vary along the length of the beam. From the experimental result below, the load P varies from 0 to 200 N, and half length of the beam is 6 inch (about 15 cm). As such, the range for the bending moment is from 0 to 15 N.m. The influence of the bending moment on the strength of the laminate can be examined by examining the strains at the bottom of the laminate. At the bottom of the laminate (90° layers), z=2.5 mm, and from (142), the strain is −3500 με. This shows that the strains on the 90° layers are always compressive. The 24 inch long sample was subjected to fatigue test under three-point bending with maximum displacement of 2.4 mm and minimum displacement of 0.24 mm for 175,000 cycles. The spring constant of the laminate did not change after the fatigue test.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the methods and systems for 4D printing of composites may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be obvious to those skilled in the art that changes and modifications may be made without departing from this invention in its broader aspects. The scope of the following claims should not be limited by the embodiments set forth in the examples, but should be given the broadest reasonable interpretation consistent with the description as a whole.

What is claimed is:

1. A method for four-dimensional printing of a composite structure, the method comprising:
obtaining a composite layer arrangement for forming a composite laminate having a substantially flat profile;
depositing a plurality of composite layers according to the composite layer arrangement to form the composite laminate, each one of the plurality of composite layers comprising longitudinal fibers having a longitudinal direction; and
activating the composite laminate to produce the composite structure comprising at least one curvature.

2. The method of claim 1, wherein activating the composite laminate comprises:
heating the composite laminate to a first temperature; and
cooling the composite laminate from the first temperature to a second temperature to produce the composite structure comprising at least one curvature.

3. The method of claim 2, wherein obtaining the composite layer arrangement comprises:
generating a model of the composite laminate;
determining a reconfiguration of the composite laminate that is expected to occur when the composite laminate corresponding to the model is activated to produce the three-dimensional composite structure; and
generating the composite layer arrangement based on the reconfiguration.

4. The method of claim 3, wherein generating the model of the composite laminate comprises modeling a shrinkage of resin used in the plurality of composite layers and modeling coefficients of thermal contraction of the plurality of composite layers.

5. The method of claim 4, wherein said modeling comprises generating a laminate matrix indicative of shrinkage of the resin and of the coefficients of thermal contraction.

6. The method of claim 3, wherein determining the reconfiguration comprises determining a radius of curvature of the composite laminate that is expected to occur when the composite laminate corresponding to the model is activated.

7. The method of claim 3, wherein determining the reconfiguration comprises determining the reconfiguration based on a shrinkage of the resin used in the plurality of composite layers and on a difference in coefficients of thermal contraction of each layer of the plurality of composite layers.

8. The method of claim 3, wherein determining the reconfiguration comprises determining the reconfiguration due to heating of the composite laminate to the first temperature and cooling of the composite structure to the second temperature.

9. The method of claim 8, wherein determining the reconfiguration comprises determining the reconfiguration based on a temperate difference between the first temperature and the second temperature.

10. A system for four-dimensional printing of a composite structure, the system comprising:
an automated fiber placement machine comprising:
a fiber placement head for depositing a plurality of composite layers onto a surface;
a control unit comprising at least one processing unit and a non-transitory computer-readable memory having stored thereon program instructions executable by the at least one processing unit for:
obtaining a composite layer arrangement for forming a composite laminate having a substantially flat profile; and
causing the fiber placement head to deposit the plurality of composite layers according to the composite layer arrangement to form the composite laminate, each one of the plurality of composite layers comprising longitudinal fibers having a longitudinal direction; and
an activation unit for activating the composite laminate to produce the composite structure comprising at least one curvature.

11. The system of claim 10, wherein activating the composite laminate comprises:
heating the composite laminate to a first temperature to produce the three-dimensional composite structure; and
cooling the three-dimensional composite structure to a second temperature thereby modifying the at least one curvature of the three-dimensional composite structure.

12. The system of claim 11, wherein obtaining the composite layer arrangement comprises:
generating a model of the composite laminate;
determining a reconfiguration of the composite laminate that is expected to occur when the composite laminate corresponding to the model is activated to produce the three-dimensional composite structure; and
generating the composite layer arrangement based on the reconfiguration.

13. The system of claim 11, wherein generating the model of the composite laminate comprises modeling a shrinkage of resin used in the plurality of composite layers and modeling coefficients of thermal contraction of the plurality of composite layers.

14. The system of claim 13, wherein said modeling comprises generating a laminate matrix indicative of shrinkage of the resin and of the coefficients of thermal contraction.

15. The system of claim 12, wherein determining the reconfiguration comprises determining a radius of curvature of the composite laminate that is expected to occur when the composite laminate corresponding to the model is activated.

16. The system of claim 12, wherein determining the reconfiguration comprises determining the reconfiguration based on a shrinkage of the resin used in the plurality of composite layers and on a difference in coefficients of thermal contraction of each layer of the plurality of composite layers.

17. The system of claim 12, wherein determining the reconfiguration comprises determining the reconfiguration due to heating of the composite laminate to the first temperature and cooling of the composite structure to the second temperature.

18. The system of claim 17, wherein determining the reconfiguration comprises determining the reconfiguration based on a temperate difference between the first temperature and the second temperature.
